(19) United States
(12) Patent Application Publication
(10) Pub. No.: US 2026/0030576 A1
(43) Pub. Date: Jan. 29, 2026

(54) Systems and Methods for Automated, Linked Workflows with Actionable Items

(71) Applicant: Moxo, Inc, Cupertino, CA (US)

(72) Inventors: He Huang, San Jose, CA (US); Subrah S. Iyar, Los Gatos, CA (US); Karrtik Rao Aria, Los Gatos, CA (US); Mukund C. Rao Aria, Los Gatos, CA (US)

(21) Appl. No.: 18/787,073

(22) Filed: Jul. 29, 2024

(51) Int. Cl. G06Q 10/0631; G06Q 10/10

(52) U.S. Cl. CPC G06Q 10/06316; G06Q 10/103

(57) ABSTRACT

An automated workflow system may include at least one memory storing instructions and at least one processor configured to execute the instructions to perform operations. The operations may include automatically communicating first workflow presentation instructions to a first user device. The first workflow presentation instructions may be configured to present a first workflow to a first user. The first workflow may include a first sequence of actionable items and a control item. The control item may have a link to a second workflow. The operations may include automatically communicating second workflow presentation instructions to a second user device. The second workflow presentation instructions may be configured to present the second workflow to a second user. The second workflow may include a second sequence of actionable items.

### BACKGROUND

Business service teams implementing and managing complex services may gain efficiency from automated workflows, especially when a plurality of users are involved in the workflow.

Conventional approaches to automated workflow may include providing a first workflow to a first group of users. In many conventional approaches, a second workflow may be provided to a second group of users. The second workflow may be separate and distinct from the first workflow.

Problems may arise in conventional approaches when one or more items in a first workflow are related to one or more items in a second workflow. Problems may also arise in conventional approaches when users of automated workflows desire workflow completion in an efficient manner.

Accordingly, given the shortcomings of conventional approaches, a need exists for unconventional approaches that provide efficient utilization of multiple automated workflows.

This Background is provided to introduce a brief context for the Detailed Description that follows. This Background is not intended to be an aid in determining the scope of the claimed subject matter nor be viewed as limiting the claimed subject matter to implementations that solve any or all of the shortcomings or problems presented above.

### BRIEF DESCRIPTION OF THE SEVERAL VIEWS OF THE DRAWINGS

The accompanying drawings, which are incorporated in and constitute a part of this specification, illustrate several embodiments and, together with the description, serve to explain the disclosed principles. In the drawings:

FIG. 1 depicts an example environment for providing an automated workflow, consistent with disclosed embodiments.

FIG. 2 depicts an example process for communicating workflow instructions, consistent with disclosed embodiments.

FIG. 3 depicts an example automated workflow system, consistent with disclosed embodiments.

FIG. 4 depicts an example process for automating linked workflows, consistent with disclosed embodiments.

FIG. 5 depicts an example process for executing a workflow job service for a workflow with actionable items, consistent with disclosed embodiments.

FIG. 6 depicts a first example process for automated workflow, consistent with disclosed embodiments.

FIG. 7 depicts an example computing device for automatically communicating completion instructions to an automated workflow system, consistent with disclosed embodiments.

FIG. 8 depicts an example process for automatically communicating with an automated workflow system, consistent with disclosed embodiments.

FIG. 9 depicts a second example process for automated workflow, consistent with disclosed embodiments.

FIG. 10 depicts a third example process for automated workflow, consistent with disclosed embodiments.

FIG. 11 illustrates an example workflow template presentation with example options for adding items, consistent with disclosed embodiments.

FIG. 12 illustrates an example workflow template presentation with example actionable items and an example shadow flow control item, consistent with disclosed embodiments.

FIG. 13 illustrates an example workflow template presentation with example options for an example shadow flow, consistent with disclosed embodiments.

FIG. 14 illustrates example options for configuring a shadow flow, consistent with disclosed embodiments.

FIG. 15 illustrates an example workflow template library presentation with an example first workflow template description and an example second workflow template description, consistent with disclosed embodiments.

FIG. 16 illustrates an example first workflow presentation prior to first completion instructions, consistent with disclosed embodiments.

FIG. 17 illustrates an example first workflow presentation prior to first completion instructions with an example actionable item selection, consistent with disclosed embodiments.

FIG. 18 illustrates an example first workflow presentation after example first completion instructions, consistent with disclosed embodiments.

FIG. 19 illustrates an example first workflow presentation after a second workflow has been invoked, consistent with disclosed embodiments.

FIG. 20 illustrates an example first workflow presentation after an example second workflow has been initiated, consistent with disclosed embodiments.

FIG. 21 illustrates an example second workflow presentation, consistent with disclosed embodiments.

FIG. 22 illustrates an example second workflow presentation with example data passed from a first workflow, consistent with disclosed embodiments.

FIG. 23 illustrates an example second workflow presentation after example second completion instructions, consistent with disclosed embodiments.

FIG. 24 illustrates an example first workflow presentation after an example second workflow has completed, consistent with disclosed embodiments.

FIG. 25 illustrates an example modified workflow presentation, consistent with disclosed embodiments.

### DETAILED DESCRIPTION OF EMBODIMENTS

The disclosed embodiments provide unconventional systems, devices, and methods for automated, linked workflows. Embodiments consistent with the present disclosure are rooted in computer technology and may be implemented using a combination of conventional hardware and software as well as specialized hardware and software, such as one or more systems and/or devices constructed and/or programmed specifically for performing disclosed operations and/or functions associated with the disclosed methods. The following discloses example embodiments which are explanatory only and are not restrictive of the claims.

The disclosed systems and methods provide greater efficiency over conventional approaches to implementing multiple workflows, especially when one or more items in a first workflow for a first user(s) are related to one or more items in a second workflow for a second user(s). The disclosed systems and methods provide greater efficiency over conventional approaches that require separate and distinct workflows. The disclosed systems and methods provide greater efficiency over conventional approaches that require utilizing separate workflow and collaboration applications. The disclosed systems and methods provide greater efficiency over conventional approaches that don't support reassigning one or more action items in a workflow from one user to another user.

As used herein, a workflow is a flow or sequence of action items or activities desired to reach a business goal. A sequence of action items or activities may be customizable. A sequence of action items or activities may be repeatable.

As used herein, an automated workflow is implemented in a computing environment. An automated workflow may be provided as part of a computer implemented workspace.

As used herein, an actionable item is an action item or activity that is actionable to a user through employment of one or more of the disclosed systems and/or devices. An actionable item may be associated with specific operations and/or functions that may be executed by the computer technology disclosed herein.

As used herein, a control item is an item that may be part of a workflow. A control item may be added to a workflow. A control item may be located before a sequence of actionable items. A control item may be located after a sequence of actionable items. A control item may be located between two actionable items in a sequence of actionable items.

As used herein, a linked workflow is a workflow that is linked to another separate workflow. At least one of the workflow and/or the separate workflow comprises a link that points to the other workflow. The workflow and the separate workflow may be distinct. Each of the workflow and the separate workflow may be provided as part of a distinct computer implemented workspace. Each of the workflow and the separate workflow may be assigned to a distinct user or distinct group of users.

As used herein, a collaboration feed is implemented in a computing environment. A collaboration feed may be provided as part of a computer implemented workspace. A collaboration feed may be configured to enable two or more users to communicate. A collaboration feed may be configured to illustrate a stream of communication content between two or more users. The two or more users may be associated with a specific workflow.

Embodiments consistent with the present disclosure may include an automated workflow system. The automated workflow system may be coupled to a computer network. The automated workflow system may comprise at least one memory storing instructions. The automated workflow system may comprise at least one processor configured to execute the instructions to perform operations. The operations may comprise automatically communicating first workflow presentation instructions to a first user device. The first workflow presentation instructions may be configured to present a first workflow to a first user of the first user device. The first user may be part of a first team or first workgroup. The first workflow may comprise a first sequence of actionable items. The first workflow may comprise a control item. The control item may comprise a link to a second workflow. The link may point to a start of the second workflow. The link may be hidden from the first user device. The second workflow may be hidden from the first user device. The operations may comprise electronically receiving first completion instructions from the first user device. The first completion instructions may comprise first data. The operations may comprise automatically communicating second workflow presentation instructions to a second user device. The second workflow presentation instructions may be configured to present the second workflow to a second user of the second user device. The second user may be part of a second team or second workgroup. The first team and the second team may be distinct. The first workgroup and the second workgroup may be distinct. The second workflow may comprise a second sequence of actionable items. The operations may comprise electronically receiving second completion instructions from the second user device. The second completion instructions may comprise second data.

In some embodiments, data may be passed from a first workflow to a second workflow. For example, a first user (e.g., a customer) may complete a form as part of the first workflow. The second workflow may comprise an approval by a second user (e.g., an employee of an organization serving the customer) of at least one response provided in the form by the first user. In some embodiments, data may be passed from the second workflow to the first workflow. For example, a file may be uploaded as part of a second workflow. A first workflow may comprise an approval of the file provided by the second user. In some embodiments, actions completed in a second workflow may trigger updates in a first workflow. For example, completion of a last actionable item in the second workflow may trigger automatic generation of a modified version of the first workflow. Providing the ability for users to pass data between workflows provides greater efficiency over conventional approaches where users may need to download data from one workflow and upload the data to another workflow.

In some embodiments, a first workflow may be configured for users external to an organization. A second workflow may be configured for users internal to the organization. The second workflow may be hidden from the users external to the organization. Links in the first workflow may be hidden from the users external to the organization.

In some embodiments, completion instructions may be received from a user device while one or more actionable items in a sequence of actionable items remain actionable to a user of the user device. The ability for the user to utilize the actionable items of a workflow may be referred to as being in the workflow. The ability for a user to receive updates from a second workflow while being in the workflow of a first workflow provides greater efficiency over conventional approaches that require separate and distinct workflows. In these conventional approaches, there may not be any automation between one or more items in a second workflow that are related to one or more items in a first workflow.

In some embodiments, a link in a first workflow may point to a start of a second workflow. The link may point to an actionable item in the second workflow. An actionable item in the second workflow may point to a control item in the first workflow.

In some embodiments, a first workflow may comprise a first control item and a second control item. The first control item may be employed to link the first workflow to a second workflow. For example, the first control item may be employed to initiate the second workflow. In some embodiments, the second workflow may comprise a third control item. The third control item may be employed to link the second workflow to the first workflow. For example, the third control item may be linked to the second control item in the first workflow. In this example, items past the second control item in the first workflow may be actionable after the third control item in the second workflow is complete. In this example, items in the first workflow that are in between the first control item and the second control item may remain actionable while the second workflow is in progress.

In some embodiments, a second sequence of actionable items in a second workflow may be nonactionable to a second user device until after first completion instructions are received from a first user device.

In some embodiments, actionable items past a control item in a first workflow may be nonactionable to a first user device until after second completion instructions are received from a second user device. In these embodiments, the control item may comprise a wait option. The control item may be configured to wait until a second workflow is complete. The control item may be configured to present a percentage of completion of the second workflow. The control item may be configured to present a list of actionable items in the second workflow. The control item may be configured to present a completion status of one or more of the actionable items in the list.

In some embodiments, operations may comprise automatically generating a modified version of a first workflow. The modified version may comprise actionable items past a control item being actionable. The items past the control item may be actionable after receiving second completion instructions from a second user device. The operations may comprise automatically communicating modified workflow presentation instructions to a first user device. The modified workflow presentation instructions may be configured to present the modified version of the first workflow to a user of the first device.

In some embodiments, first data may comprise data provided by a first user. The first data may be communicated to a second workflow. First data may comprise a notification of completion of an actionable item preceding the control item in a first workflow. The actionable item may be in the first sequence of actionable items. First data may comprise the data provided by the first user and the notification of completion.

In some embodiments, second data may comprise data provided by a second user. The second data may be communicated to a first workflow. The second data may comprise a notification of completion of an actionable item in the second sequence of actionable items. The second data may comprise a notification that the second workflow has completed. The second data may comprise any combination of: the data provided by the second user, the notification of completion, and the notification that the second workflow has completed.

In some embodiments, operations may comprise electronically receiving workflow modification instructions from a user device. The workflow modification instructions may comprise a request to modify a workflow. The operations may comprise automatically generating a modified workflow based on the workflow modification instructions.

In some embodiments, a request to modify a workflow may comprise adding an actionable item. The actionable item may be added to the workflow while a user is in the workflow.

In some embodiments, a request to modify a workflow may comprise removing an actionable item. The actionable item may be removed from the workflow while a user is in the workflow.

In some embodiments, a request to modify a workflow may comprise marking an actionable item as complete. The actionable item may be marked complete while a user is in the workflow.

In some embodiments, actionable items may comprise a form, a file request, an approval, an acknowledgement, a signature, a calendar item, a task, an integration, and/or any other type of item or activity employed to reach a business goal. A form may comprise an upload of a form, a completion of filling out a form, a download of a form, and/or any other type of form activity while a user is in a workflow. A task may comprise a to do item. A file request may comprise requesting a file and/or fulfilling a request while a user is in the workflow. An approval may comprise approving an actionable item by a user while the user is in the workflow. An acknowledgement may comprise acknowledging an actionable item while a user is in the workflow. A signature may comprise signing a form and/or a document while a user is in the workflow. The signature may comprise an electronic signature. A calendar item may comprise adding an entry on a calendar and/or booking time on a calendar for one or more additional users while a user is in the workflow. For example, the entry on the calendar may be related to a call, a meeting, or a video meeting. A task may comprise assigning a task to one or more users while a user is in the workflow. An integration may comprise loading an external application from a third party service provider while the user is in the workflow. For example, an external application may comprise a document signing application or an identity verification application. A milestone may comprise setting a milestone related to one or more actionable items while a user is in the workflow.

In some embodiments, one or more actionable items may include access to an Application Programming Interface (API) associated with a third party service. The third party service may be provided through a web application. Access to the API may be added to a workflow while a user is in the workflow.

In some embodiments, a request to modify a first workflow may comprise adding a control item. The control item may be employed to link to a second workflow. In this configuration, the second workflow may be referred to as a shadow flow. The first workflow may be referred to as a main flow. A shadow flow may be a subflow within a main flow. The subflow may be configured for users internal to an organization. The main flow may be configured for users external to the organization. A control item may comprise a wait option.

Some embodiments may include a workflow template database. The workflow template database may be configured to store a plurality of workflow templates. At least some of the workflow templates may comprise a first workflow having a first sequence of actionable items. One or more of the first workflows may comprise one or more control items. At least one of the workflow templates may comprise a second workflow having a second sequence of actionable items.

In some embodiments, operations may comprise automatically communicating workflow template instructions to a user device. The workflow template instructions may be configured to present a plurality of workflow templates to a user of the user device. Each of the workflow templates may have a sequence of actionable items. At least one of the workflow templates may comprise one or more control items. The operations may comprise electronically receiving a workflow template selection from the user device. The workflow template selection may comprise a request to select one of the workflow templates. The operations may comprise automatically communicating modified workflow template instructions to the user device. The modified workflow template instructions may be configured to present a specific workflow template to the user. The specific workflow template may be based on the workflow template selection.

In some embodiments, selection of a workflow template may be associated with a first workflow. The first workflow may comprise a link to a second workflow. The first workflow may comprise a control item. The control item may comprise the link to the second workflow. The control item may comprise a wait option. The wait option may be added to the first workflow after selection of a workflow template. The link may be added to the first workflow after selection of a workflow template. One or more control items may be added to the first workflow after selection of a workflow template. The second workflow may be linked to the first workflow. The second workflow may be linked to the control item in the first workflow. The second workflow may be linked to the first workflow after the control item is added.

Some embodiments may include an audit database. Operations may comprise storing first completion instructions in the audit database. Operations may comprise storing second completion instructions in the audit database. Operations may comprise storing workflow modification instructions in the audit database.

In some embodiments, one or more actionable items may be assignable to one or more users. Each of the one or more users may be associated with a workflow role.

In some embodiments, operations may comprise electronically receiving reassignment instructions from a user device. The reassignment instructions may comprise a request to reassign one or more actionable items from one user to another user. The operations may comprise automatically generating an updated workflow based on the reassignment instructions. The operations may comprise automatically communicating updated workflow presentation instructions to the user device. The updated workflow presentation instructions may be configured to present the updated workflow.

In some embodiments, reassignment instructions may be received from a user device while a sequence of actionable items remain actionable to a user of the user device.

Some embodiments may include an audit database. Operations may comprise storing reassignment instructions in the audit database.

In some embodiments, operations may comprise automatically communicating first feed instructions to a user device. The first feed instructions may be configured to present a collaboration feed to a user of the user device. The operations may comprise electronically receiving collaboration instructions from the user device. The collaboration instructions may comprise a request to add a collaboration item to the collaboration feed. The operations may comprise automatically generating a modified collaboration feed. The modified collaboration feed may be based on the collaboration instructions. The operations may comprise automatically communicating modified feed instructions to the user device. The modified feed instructions may be configured to present the modified collaboration feed to the user.

In some embodiments, collaboration instructions may be received from a user device while a sequence of actionable items remain actionable to a user of the user device. The ability for a user to request additions and/or view one or more additions to a communication feed related to a workflow while being in the workflow provides greater efficiency over conventional approaches where communication feeds and workflows are provided by separate applications.

In some embodiments, a collaboration item may comprise a message comprising text, a message comprising a video, a request for a video meeting, a file, a link to a file, a link to a data repository, an annotation, and/or any other type of collaborative content.

In some embodiments, a collaboration feed and/or a modified collaboration feed may be associated with a specific actionable item in a workflow. In these embodiments, the collaboration feed and/or the modified collaboration feed may be available to users associated with the specific actionable item.

In some embodiments, a collaboration feed and/or a modified collaboration feed may be associated with a workflow. In these embodiments, the collaboration feed and/or the modified collaboration feed may be available to users associated with the workflow.

Some embodiments may include an audit database. Operations may comprise storing collaboration instructions in the audit database.

Embodiments consistent with the present disclosure may include a method for automating workflow. The method may comprise automatically communicating first workflow presentation instructions to a first user device. The first workflow presentation instructions may be configured to present a first workflow to a first user. The first user may be part of a first team or first workgroup. The first workflow may comprise a first sequence of actionable items. The first workflow may comprise a control item. The control item may comprise a link to a second workflow. The link may point to a start of the second workflow. The link may be hidden from the first user device. The second workflow may be hidden from the first user device. The method may comprise electronically receiving first completion instructions from the first user device. The first completion instructions may comprise first data. The method may comprise automatically communicating second workflow presentation instructions to a second user device. The second workflow presentation instructions may be configured to present the second workflow to a second user. The second user may be part of a second team or second workgroup. The first team and the second team may be distinct. The first workgroup and the second workgroup may be distinct. The second workflow may comprise a second sequence of actionable items. The method may comprise electronically receiving second completion instructions from the second user device. The second completion instructions may comprise second data.

In some embodiments, a method may comprise automatically generating a modified version of a first workflow. The modified version may comprise actionable items past a control item being actionable. The items past the control item may be actionable after receiving second completion instructions from a second user device. The operations may comprise automatically communicating modified workflow presentation instructions to a first user device. The modified workflow presentation instructions may be configured to present the modified version of the first workflow to a user of the first device.

Embodiments consistent with the present disclosure may include a computing device. The computing device may be coupled to a computer network. The computing device may comprise at least one memory storing instructions. The computing device may comprise at least one processor configured to execute the instructions to perform operations. The operations may comprise electronically receiving workflow presentation instructions from an automated workflow system. The workflow presentation instructions may be configured to present a first workflow to a user. The first workflow may comprise a sequence of actionable items. The first workflow may comprise a control item. The control item may comprise a link to a second workflow. The operations may comprise automatically communicating completion instructions to the automated workflow system. The completion instructions may comprise completion data.

In some embodiments, completion instructions may be communicated to an automated workflow system from a computing device while one or more actionable items in a sequence of actionable items remain actionable to a user of a computing device.

In some embodiments, actionable items past a control item in a first workflow may be nonactionable to a user. The nonactionable condition may be temporary.

In some embodiments, operations may comprise electronically receiving modified workflow presentation instructions from an automated workflow system. The modified workflow presentation instructions may be configured to present a modified workflow to a user. The modified workflow may comprise actionable items past a control item being actionable to the user.

In some embodiments, completion data may comprise data provided by a user. Data provided by a user in a first workflow may be communicated to a second workflow. Completion data may comprise a notification of completion of an actionable item. The actionable item may precede a control item in the first workflow. Completion data may comprise the data provided by the user and the notification of completion.

In some embodiments, operations may comprise electronically receiving feed instructions from an automated workflow system. The feed instructions may be configured to present a collaboration feed to a user. The operations may comprise automatically communicating collaboration instructions to the automated workflow system. The collaboration instructions may comprise a request to add a collaboration item to the collaboration feed. The operations may comprise electronically receiving modified feed instructions from the automated workflow system. The modified feed instructions may be configured to present a modified collaboration feed to the user. The modified collaboration feed may be based on the collaboration instructions.

In some embodiments, collaboration instructions may be communicated to an automated workflow system from a computing device while one or more actionable items in a sequence of actionable items remain actionable to a user of the computing device.

In some embodiments, operations may comprise electronically receiving workflow template instructions from an automated workflow system. The workflow template instructions may be configured to present a plurality of workflow templates to a user of a first computing device. Each of the workflow templates may have a sequence of actionable items. The operations may comprise automatically communicating a workflow template selection to the automated workflow system. The workflow template selection may comprise a request to select one of the workflow templates. The operations may comprise electronically receiving modified workflow template instructions from the automated workflow system. The modified workflow template instructions may be configured to present a specific workflow template to the user. The specific workflow template may be based on the workflow template selection.

In some embodiments, one or more actionable items may be assignable to one or more users associated with a workflow.

In some embodiments, operations may comprise automatically communicating reassignment instructions to an automated workflow system. The reassignment instructions may comprise a request to reassign one or more actionable items from one user to another user. The operations may comprise electronically receiving updated workflow presentation instructions from the automated workflow system. The updated workflow presentation instructions may be configured to present an updated workflow. The updated workflow may be based on the reassignment instructions.

In some embodiments, reassignment instructions may be communicated to an automated workflow system from a computing device while one or more actionable items in a sequence of actionable items remain actionable to a user of the computing device.

Embodiments consistent with the present disclosure may include a method for automating workflow. The method may comprise electronically receiving workflow presentation instructions from an automated workflow system. The workflow presentation instructions may be configured to present a first workflow to a user. The first workflow may comprise a sequence of actionable items. The first workflow may comprise a control item. The control item may comprise a link to a second workflow. The method may comprise automatically communicating completion instructions to the automated workflow system. The completion instructions may comprise completion data.

In some embodiments, a method may comprise electronically receiving modified workflow presentation instructions from an automated workflow system. The modified workflow presentation instructions may be configured to present a modified workflow to a user. The modified workflow may comprise actionable items past a control item being actionable to the user.

In some embodiments, a method may comprise electronically receiving workflow template instructions from an automated workflow system. The workflow template instructions may be configured to present a plurality of workflow templates to a user. Each of the workflow templates may have a sequence of actionable items. The method may comprise automatically communicating a workflow template selection to the automated workflow system. The workflow template selection may comprise a request to select one of workflow templates. The method may comprise electronically receiving modified workflow template instructions from the automated workflow system. The modified workflow template instructions may be configured to present a specific workflow to the user. The specific workflow may be based on the workflow template selection.

In some embodiments, a method may comprise electronically receiving feed instructions from an automated workflow system. The instructions may be configured to present a collaboration feed to a user. The method may comprise automatically communicating collaboration instructions to the automated workflow system. The collaboration instructions may comprise a request to add a collaboration item to the collaboration feed. The method may comprise electronically receiving modified feed instructions from the automated workflow system. The modified feed instructions may be configured to present a modified collaboration feed to the user. The modified collaboration feed may be based on the collaboration instructions. Embodiments consistent with the present disclosure may include a computing device.

The computing device may be coupled to a computer network. The computing device may comprise at least one memory storing instructions. The computing device may comprise at least one processor configured to execute the instructions to perform operations. The operations may comprise electronically receiving workflow presentation instructions from an automated workflow system. The workflow presentation instructions may be configured to present a second workflow to a user. The second workflow may comprise a sequence of actionable items. The second workflow may be linked to a first workflow. The second workflow may be linked to the first workflow by a link in the first workflow. The operations may comprise automatically communicating completion instructions to the automated workflow system. The completion instructions may comprise completion data.

In some embodiments, one or more actionable items in a sequence of actionable items may be nonactionable to a user. The nonactionable condition may be temporary.

In some embodiments, operations may comprise electronically receiving modified workflow presentation instructions from an automated workflow system. The modified workflow presentation instructions may be configured to present a modified workflow to a user. The modified workflow may comprise actionable items being actionable to the user.

In some embodiments, completion data may comprise data provided by a user. Data provided by a user in a second workflow may be communicated to a first workflow. Completion data may comprise a notification of completion of an actionable item. Completion data may comprise a notification that the second workflow has completed. Completion data may comprise any combination of: the data provided by the user, the notification of completion of an actionable item, and the notification that the second workflow has completed.

Embodiments consistent with the present disclosure may include a method for automating workflow. The method may comprise electronically receiving workflow presentation instructions from an automated workflow system. The workflow presentation instructions may be configured to present a second workflow to a user. The second workflow may comprise a sequence of actionable items. The second workflow may be linked to a first workflow. The second workflow may be linked to a first workflow by a link in the first workflow. The method may comprise automatically communicating completion instructions to the automated workflow system. The completion instructions may comprise completion data.

In some embodiments, a method may comprise electronically receiving modified workflow presentation instructions from an automated workflow system. The modified workflow presentation instructions may be configured to present a modified workflow to a user. The modified workflow may comprise actionable items being actionable to the user.

Reference will now be made in detail to example embodiments, examples of which are illustrated in the accompanying drawings and disclosed herein. The disclosed embodiments are described in sufficient detail to enable those skilled in the art to practice the disclosed embodiments. It is to be understood that other embodiments may be utilized and that changes may be made without departing from the scope of the disclosed embodiments. Thus, the components, methods, and examples are illustrative only and are not intended to be necessarily limiting. As will be appreciated by one skilled in the art, the components and arrangement of components included in the disclosed systems and devices may vary. For example, an automated workflow system may further include other components or devices not depicted in the accompanying drawings that perform or assist in the performance of one or more processes consistent with the disclosed embodiments. In another example, a user device may further include other components or devices not depicted in the accompanying drawings that perform or assist in the performance of one or more processes consistent with the disclosed embodiments. In yet another example, a computing device may further include other components or devices not depicted in the accompanying drawings that perform or assist in the performance of one or more processes consistent with the disclosed embodiments. The components and arrangements shown in the accompanying drawings are not intended to limit the disclosed embodiments, as the components used to implement the disclosed processes and features may vary.

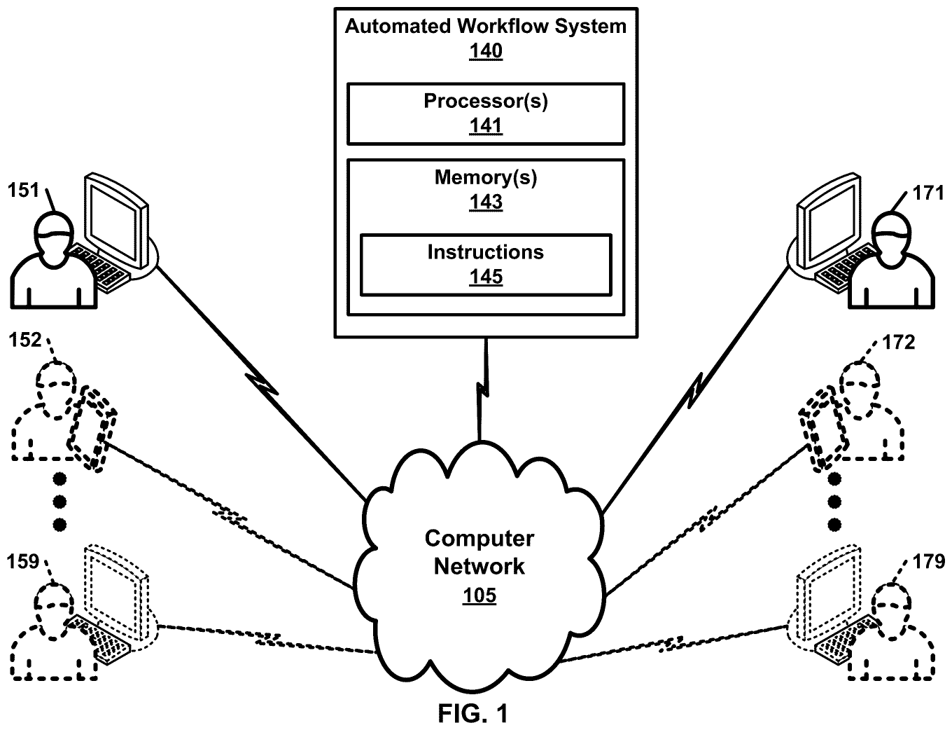

FIG. 1 depicts an example environment for providing an automated workflow, consistent with disclosed embodiments. Automated workflow system 140 may be communicatively coupled to computer network 105. The automated workflow system 140 may comprise at least one memory 143. The at least one memory 143 may be configured to store instructions 145. The automated workflow system 140 may comprise at least one processor 141. The at least one processor 141 may be configured to execute the instructions 145 to perform operations. One or more first user devices (151, 152, . . . 159) may be communicatively coupled to the computer network 105. Users of the one or more first user devices (151, 152, . . . 159) may be external to an organization. One or more second user devices (171, 172, . . . 179) may be communicatively coupled to the computer network 105. Users of the one or more second user devices (171, 172, . . . 179) may be internal to the organization.

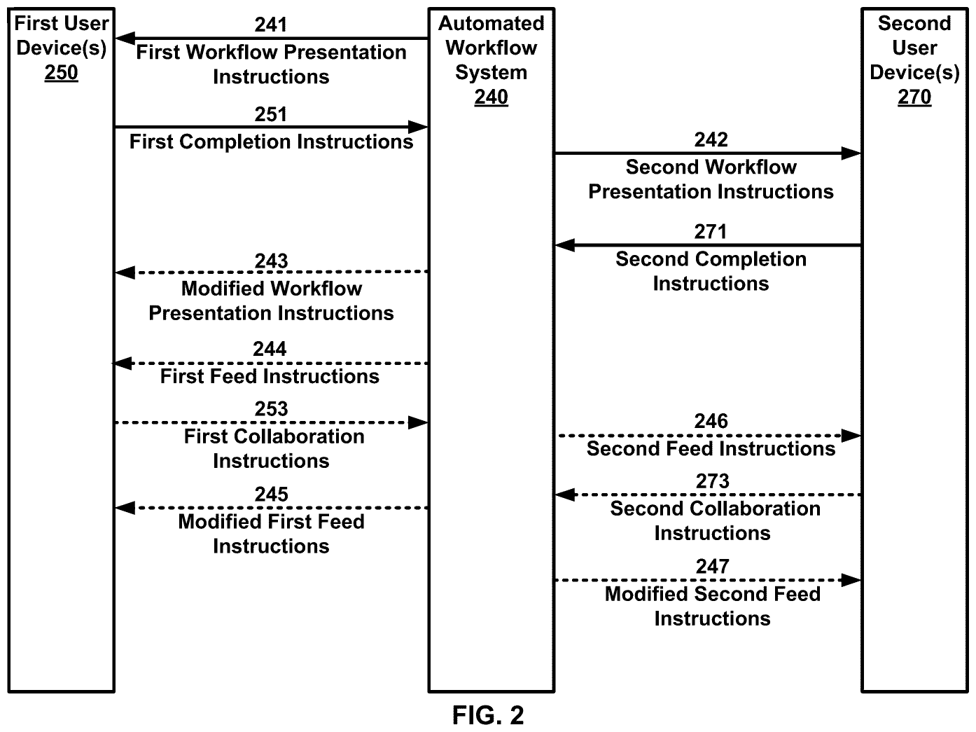

FIG. 2 depicts an example process for communicating workflow instructions, consistent with disclosed embodiments. Automated workflow system 240 may be configured to automatically communicate first workflow presentation instructions 241 to one or more first user devices 250. The first workflow presentation instructions 241 may be configured to present a first workflow to one or more users of the first user devices 250. The first workflow may comprise a link to a second workflow. The automated workflow system 240 may be configured to electronically receive first completion instructions 251 from one of the first user devices 250. The first completion instructions 251 may comprise first data. The automated workflow system 240 may be configured to automatically communicate second workflow presentation instructions 242 to one or more second user devices 270. The second workflow presentation instructions 242 may be configured to present the second workflow to one or more users of the second user devices 270. The automated workflow system 240 may be configured to electronically receive second completion instructions 271 from one of the second user devices 270. The second completion instructions 271 may comprise second data. The automated workflow system 240 may be configured to automatically generate a modified version of the first workflow. The automated workflow system 240 may be configured to automatically communicate modified workflow presentation instructions 243 to the one or more first user devices 250. The modified workflow presentation instructions 243 may be configured to present the modified version of the first workflow to one or more users of the first user devices 250.

The automated workflow system 240 may be configured to automatically communicate first feed instructions 244 to one or more first user devices 250. The first feed instructions 244 may be configured to present a first collaboration feed to one or more users of the first user devices 250. The automated workflow system 240 may be configured to electronically receive first collaboration instructions 253 from one of the first user devices 250. The first collaboration instructions 253 may comprise a request to add a collaboration item to the first collaboration feed. The automated workflow system 240 may be configured to automatically generate a modified first collaboration feed based on the first collaboration instructions. The automated workflow system 240 may be configured to automatically communicate modified first feed instructions 245 to one or more first user devices 250. The modified first feed instructions 245 may be configured to present the modified first collaboration feed to one or more users of the first user devices 250.

The automated workflow system 240 may be configured to automatically communicate second feed instructions 246 to one or more second user devices 270. The second feed instructions 246 may be configured to present a second collaboration feed to one or more users of the second user devices 270. The automated workflow system 240 may be configured to electronically receive second collaboration instructions 273 from one of the second user devices 270. The second collaboration instructions 273 may comprise a request to add a collaboration item to the second collaboration feed. The automated workflow system 240 may be configured to automatically generate a modified second collaboration feed based on the second collaboration instructions. The automated workflow system 240 may be configured to automatically communicate modified second feed instructions 247 to one or more second user devices 270. The modified second feed instructions 247 may be configured to present the modified second collaboration feed to one or more users of the second user devices 270.

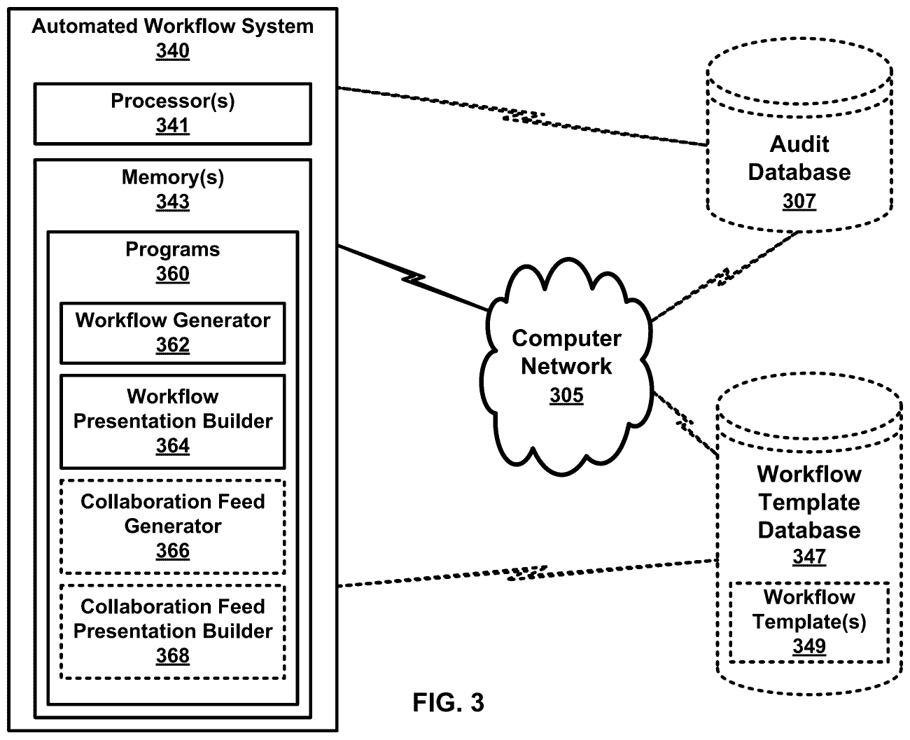

FIG. 3 depicts an example automated workflow system 340, consistent with disclosed embodiments. Automated workflow system 340 may be communicatively coupled to computer network 305. The automated workflow system 340 may be communicatively coupled to workflow template database 347. The workflow template database 347 may be configured to store one or more workflow templates 349. Each of the workflow templates 349 may comprise one or more workflows. Each workflow may comprise a sequence of actionable items. The automated workflow system 340 may be communicatively coupled to audit database 307. The automated workflow system 340 may comprise at least one memory 343. The at least one memory 343 may comprise one or more programs 360. Each of the programs 360 may comprise instructions. The automated workflow system 340 may comprise at least one processor 341. The at least one processor 341 may be configured to execute the instructions to perform operations. The programs 360 may comprise workflow generator 362. The workflow generator 362 may comprise workflow generating instructions. The programs 360 may comprise workflow presentation builder 364. The workflow presentation builder 364 may comprise workflow presentation building instructions. The programs 360 may comprise collaboration feed generator 366. The collaboration feed generator 366 may comprise collaboration feed generating instructions. The programs 360 may comprise collaboration feed presentation builder 368. The collaboration feed presentation builder 368 may comprise collaboration feed presentation building instructions.

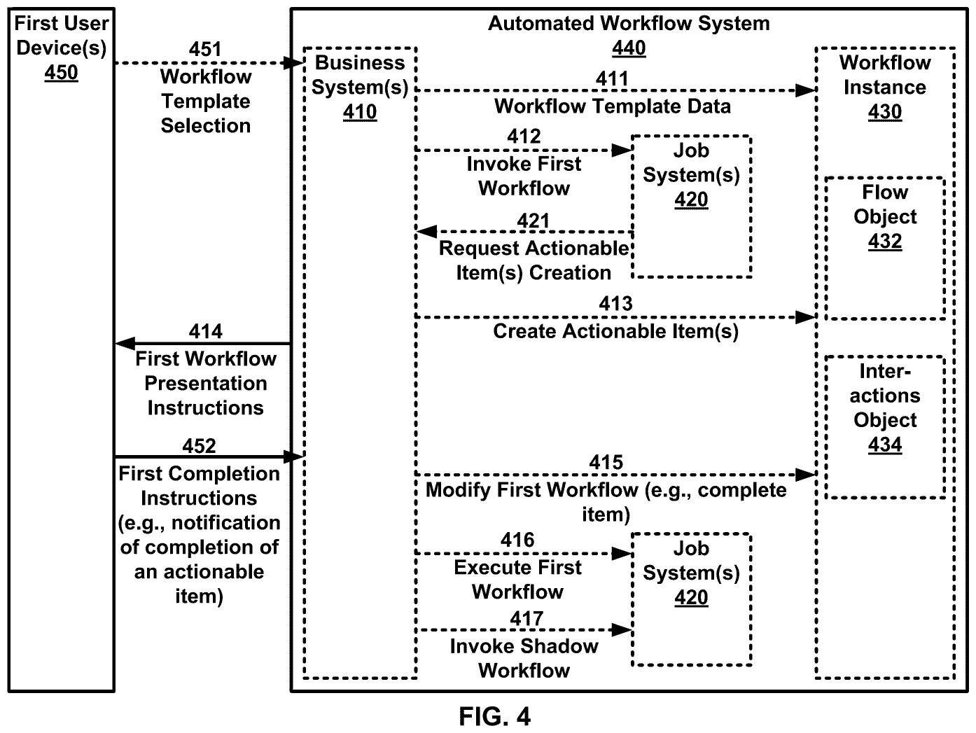

FIG. 4 depicts an example process for automating linked workflows, consistent with disclosed embodiments. Automated workflow system 440 may comprise one or more business systems 410. The one or more business systems 410 may comprise at least one memory storing business instructions. The one or more business systems 410 may comprise at least one processor configured to execute the business instructions to perform business operations. Automated workflow system 440 may comprise one or more job systems 420. The one or more job systems 420 may comprise at least one memory storing job instructions. The one or more job systems 420 may comprise at least one processor configured to execute the job instructions to perform job operations. The business operations may comprise electronically receiving a workflow template selection 451 from a first user device 450. The business operations may comprise creating a first workflow instance 430 based on workflow template data 411. The workflow template data 411 may be based on the workflow template selection 451. The first workflow instance 430 may comprise a first flow object 432. The first flow object 432 may comprise data required to implement a first workflow. The first workflow instance 430 may comprise a first interactions object 434. The first interactions object 434 may be configured to store all interactions associated with the first workflow. The business operations may comprise communicating instructions to invoke a first workflow job service 412 to one of the job systems 420. The job operations may comprise communicating a request for actionable item creation 421 for the next actionable item in the first workflow to one of the business systems 410. The business operations may comprise creating the next actionable item 413 in the first flow object 432 of the first workflow instance 430. The business operations may comprise starting the next actionable item in the first workflow. After first workflow presentation instructions 414 are communicated to one or more first user devices 450, the business operations may comprise receiving first completion instructions 452 from a first user device 450. For example, the first completion instructions 452 may comprise a notification of completion of an actionable item in the first workflow. The business operations may comprise modifying the first workflow 415. Modifying the first workflow may comprise modifying the first flow object 432 in the first workflow instance 430. In this example, modifying the first workflow 415 may comprise completing the current actionable item. The business operations may comprise communicating instructions to execute the first workflow 416 to one of the job systems 420. In the case that the next item in the first workflow is a control item for a shadow flow, the business operations may comprise communicating instructions to invoke a shadow workflow job service 417 to one of the job systems 420. At least some of these aspects may be employed in a similar manner for the shadow (or second) workflow.

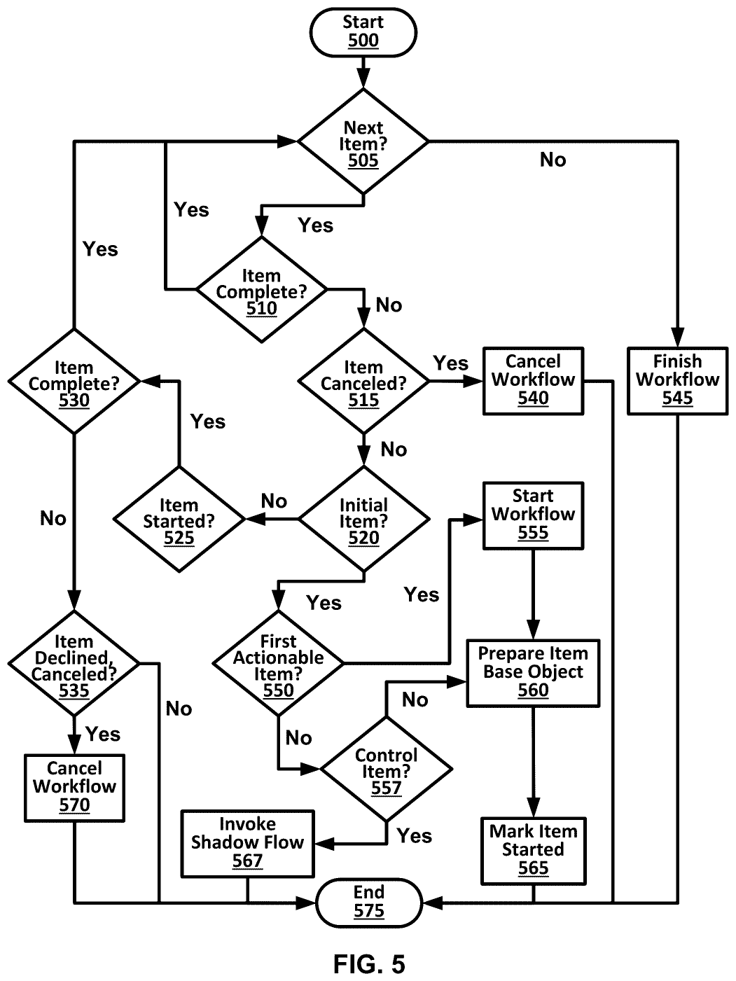

FIG. 5 depicts an example process for executing a workflow job service for a workflow with actionable items, consistent with disclosed embodiments. The process may start at 500. Existence of a next item in a workflow may be determined at 505. A completion status of the next item may be determined at 510. A cancellation status of the next item may be determined at 515. An initial status of the next item may be determined at 520. A started status of the next item may be determined at 525. A completion status of the next item may be determined at 530. A determination of the next item being declined or canceled may be made at 535. The workflow may be cancelled at 540. The workflow may be finished at 545. A determination that the next item is the first actionable item may be made at 550. The workflow may be started at 555. A determination that the next item is a control item may be made at 557. The actionable item base object may be prepared at 560. The actionable item may be marked as started at 565. A shadow flow may be invoked at 567. The workflow may be cancelled at 570. The process may end at 575. The process may be repeated when the status changes for any item in the workflow.

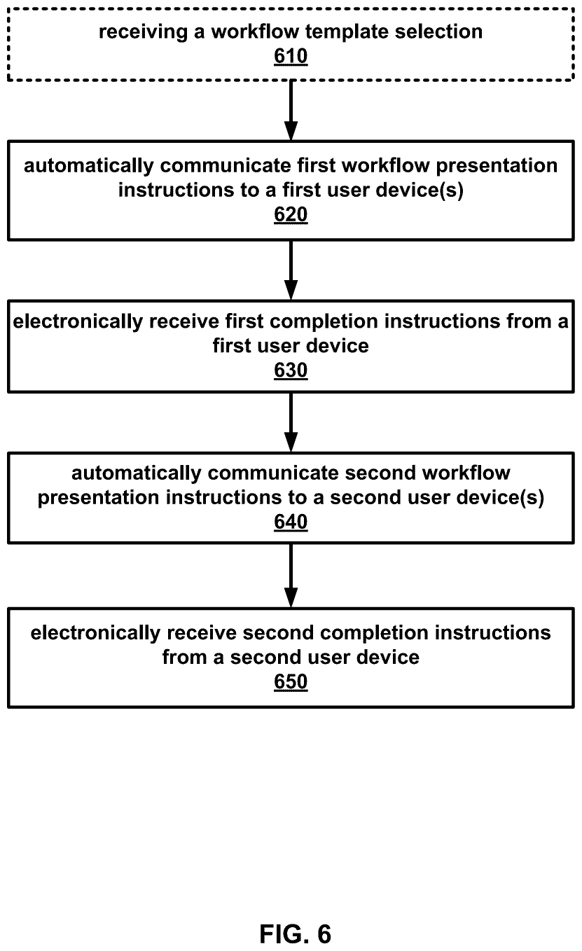

FIG. 6 depicts a first example process for automated workflow, consistent with disclosed embodiments. A selection of a workflow template may be received at 610. First workflow presentation instructions may be automatically communicated to one or more first user devices at 620. First completion instructions may be electronically received from one of the first user devices at 630. Second workflow presentation instructions may be automatically communicated to one or more second user devices at 640. Second completion instructions may be electronically received from one of the second user devices at 650.

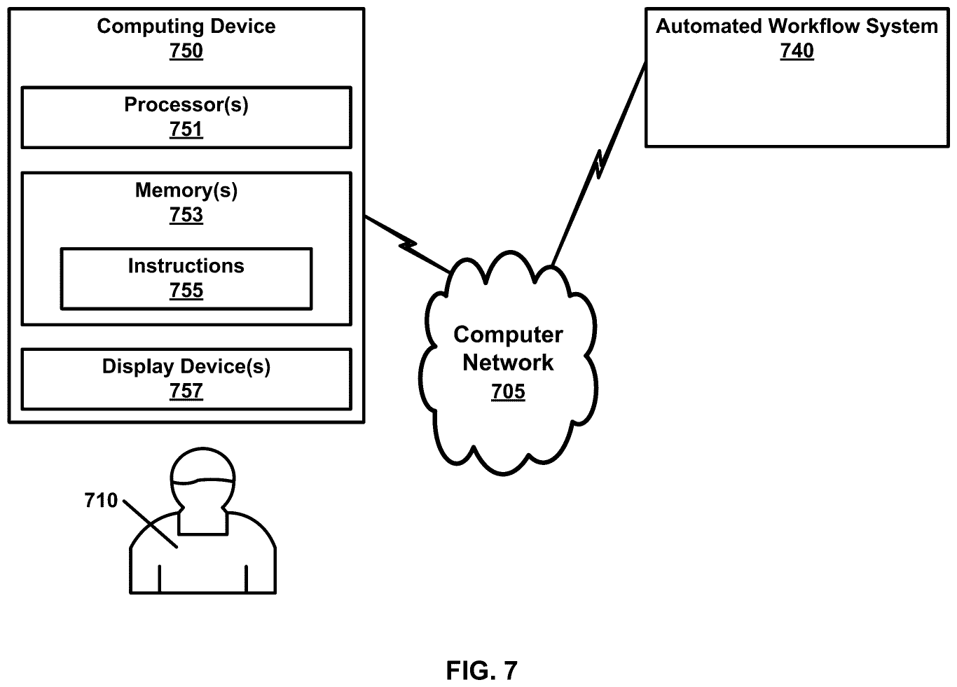

FIG. 7 depicts an example computing device 750 for automatically communicating completion instructions to an automated workflow system 740, consistent with disclosed embodiments. Computing device 750 may be communicatively coupled to computer network 705. The computer network 705 may be communicatively coupled to automated workflow system 740. The computing device 750 may comprise at least one memory 753. The at least one memory 753 may be configured to store instructions 755. The computing device 750 may comprise at least one processor 751. The at least one processor 751 may be configured to execute the instructions 755 to perform operations. The computing device 750 may comprise one or more display devices 757. The computing device 750 may be configured to present a workflow to user 710 through employment of one or more of the display devices 757.

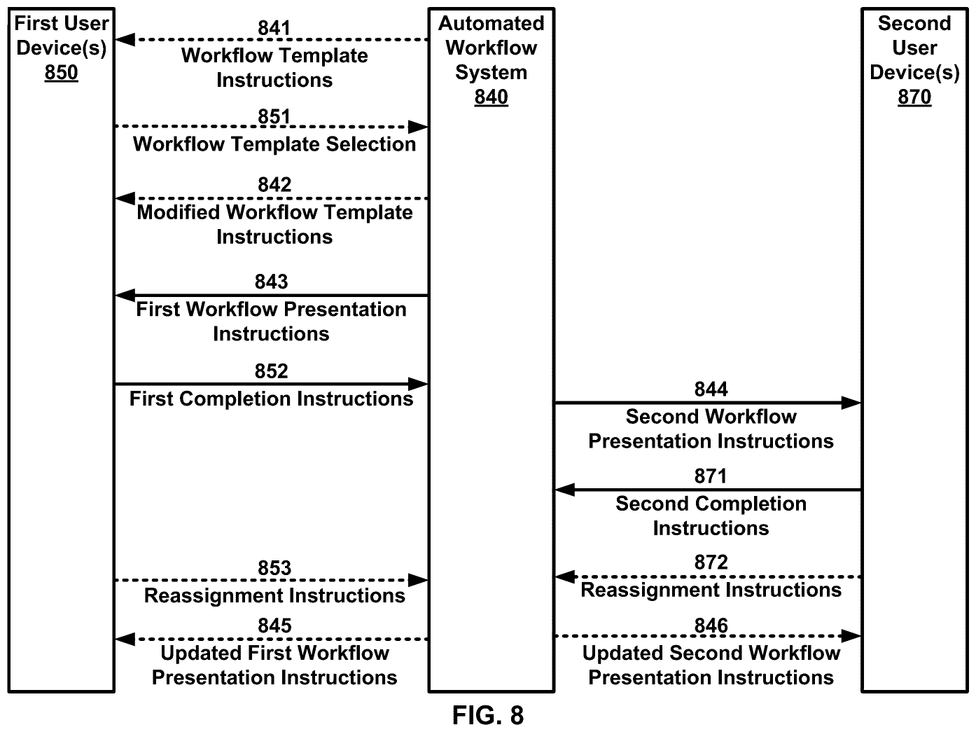

FIG. 8 depicts an example process for automatically communicating with an automated workflow system, consistent with disclosed embodiments. At least one first user device 850 may be configured to electronically receive workflow template instructions 841 from an automated workflow system 840. The at least one first user device 850 may be configured to automatically communicate a workflow template selection 851 to the automated workflow system 840. The at least one first user device 850 may be configured to electronically receive modified workflow template instructions 842 from the automated workflow system 840. The at least one first user device 850 may be configured to electronically receive first workflow presentation instructions 843 from the automated workflow system 840. The at least one first user device 850 may be configured to automatically communicate first completion instructions 852 to the automated workflow system 840. The at least one first user device 850 may be configured to automatically communicate reassignment instructions 853 to the automated workflow system 840. The at least one first user device 850 may be configured to electronically receive updated first workflow presentation instructions 845 from the automated workflow system 840.

At least one second user device 870 may be configured to electronically receive second workflow presentation instructions 844 from an automated workflow system 840. The at least one second user device 870 may be configured to automatically communicate second completion instructions 871 to the automated workflow system 840. The at least one second user device 870 may be configured to automatically communicate reassignment instructions 872 to the automated workflow system 840. The at least one second user device 870 may be configured to electronically receive updated second workflow presentation instructions 846 from the automated workflow system 840.

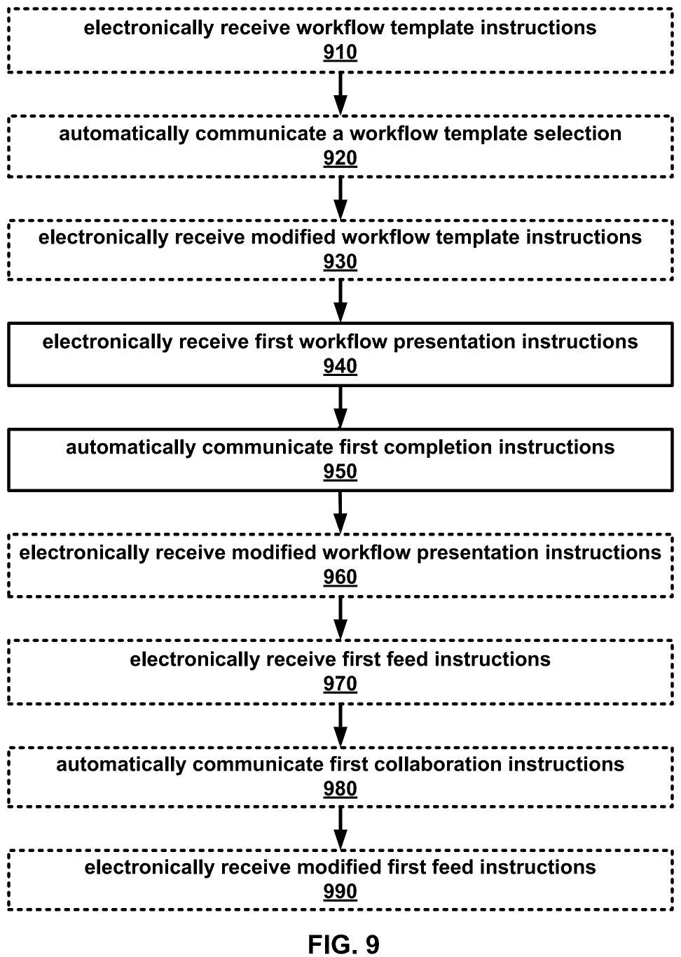

FIG. 9 depicts a second example process for automated workflow, consistent with disclosed embodiments. Workflow template instructions may be electronically received at 910. A workflow template selection may be automatically communicated at 920. Modified workflow template instructions may be electronically received at 930. First workflow presentation instructions may be electronically received at 940. First completion instructions may be automatically communicated at 950. Modified workflow presentation instructions may be electronically received at 960. First feed instructions may be electronically received at 970. First collaboration instructions may be automatically communicated at 980. Modified first feed instructions may be electronically received at 990.

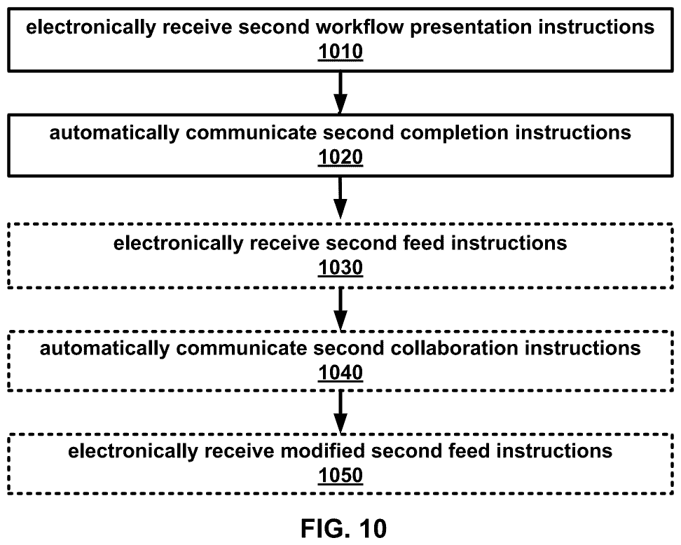

FIG. 10 depicts a third example process for automated workflow, consistent with disclosed embodiments. Second workflow presentation instructions may be electronically received at 1010. Second completion instructions may be automatically communicated at 1020. Second feed instructions may be electronically received at 1030. Second collaboration instructions may be automatically communicated at 1040. Modified second feed instructions may be electronically received at 1050.

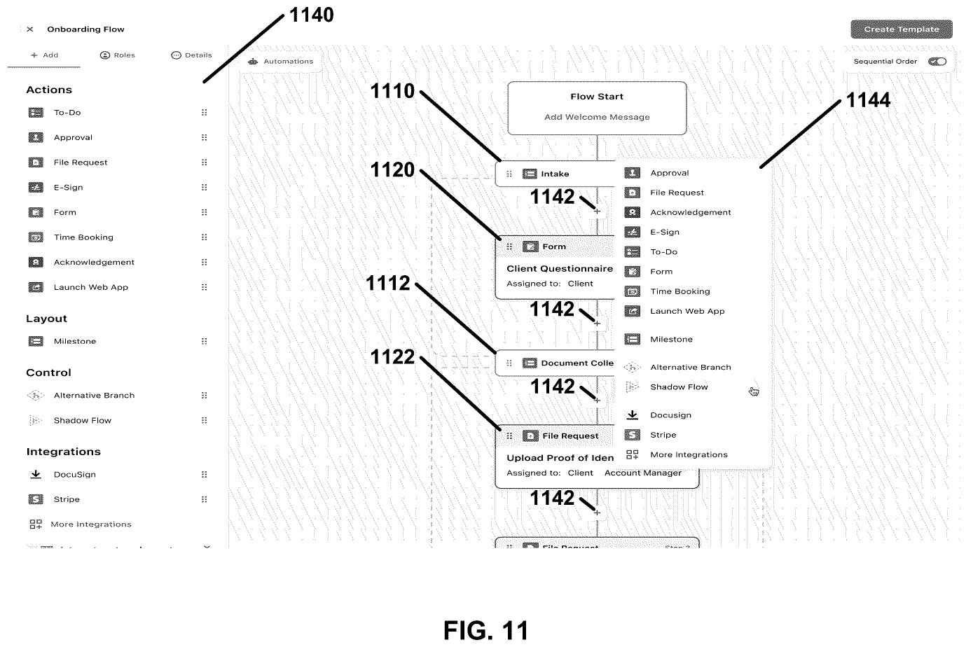

FIG. 11 illustrates an example workflow template presentation with example options for adding items, consistent with disclosed embodiments. The workflow template presentation may illustrate a workflow with a first milestone 1110. The workflow may comprise a first actionable item 1120. The first actionable item 1120 may comprise a form. In this example, the form may comprise a client questionnaire. In this example, the first actionable item 1120 is associated with the first milestone 1110. The workflow may comprise a second milestone 1112. The workflow may comprise a second actionable item 1122. The second actionable item 1122 may comprise a file request. In this example, the file request may comprise proof of identification. In this example, the second actionable item 1122 is associated with the second milestone 1112. The workflow template presentation may illustrate example options for adding example items. Example items may be presented in an example items menu 1140 and/or in an example items dialog box 1144. An item from the items menu 1140 may be dragged into the workflow to quickly add the item to the workflow. The items may comprise actionable items, layout items, control items, and/or integration items. In this example, a shadow flow control item is selected in the items dialog box 1144. One of the items may be added into the workflow at any of one or more decision points 1142.

In some embodiments, a shadow flow control item may be employed to link a shadow flow to a workflow. The workflow may be referred to as a first workflow or a main workflow. The shadow flow may be referred to as a second workflow. Once a shadow flow control item is configured, the shadow flow may be linked to the workflow. The workflow may be configured for users external to an organization. The shadow flow may be configured for users internal to the organization.

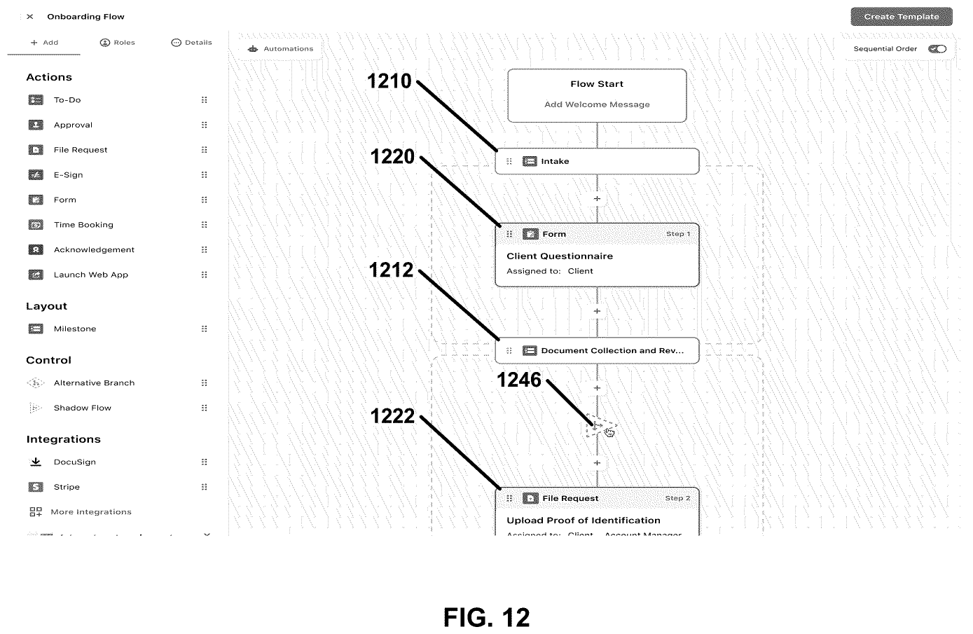

FIG. 12 illustrates an example workflow template presentation with example actionable items and an example shadow flow control item, consistent with disclosed embodiments. The workflow template presentation may illustrate a workflow with a first milestone 1210. The workflow may comprise a first actionable item 1220. The first actionable item 1220 may comprise a form. In this example, the form may comprise a client questionnaire. In this example, the first actionable item 1220 is associated with the first milestone 1210. The workflow may comprise a second milestone 1212. The workflow may comprise a shadow flow control item 1246. The workflow may comprise a second actionable item 1222. The second actionable item 1222 may comprise a file request. In this example, the file request may comprise proof of identification. In this example, the shadow flow control item 1246 and the second actionable item 1222 are associated with the second milestone 1212.

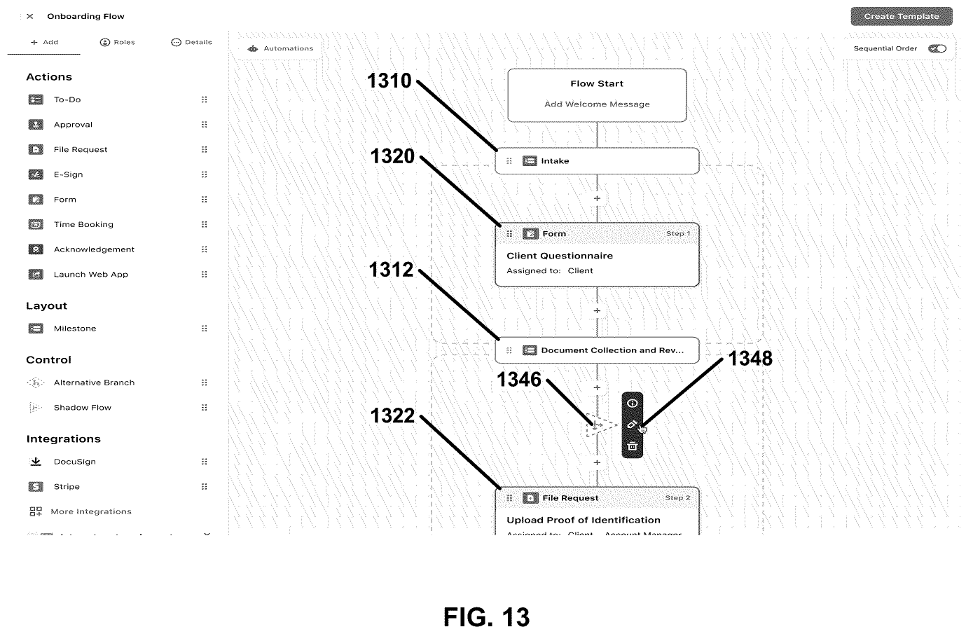

FIG. 13 illustrates an example workflow template presentation with example options for an example shadow flow, consistent with disclosed embodiments. The workflow template presentation may illustrate a workflow with a first milestone 1310. The workflow may comprise a first actionable item 1320. The first actionable item 1320 may comprise a form. In this example, the form may comprise a client questionnaire. In this example, the first actionable item 1320 is associated with the first milestone 1310. The workflow may comprise a second milestone 1312. The workflow may comprise a shadow flow control item 1346. The workflow may comprise a second actionable item 1322. The second actionable item 1322 may comprise a file request. In this example, the file request may comprise proof of identification. In this example, the shadow flow control item 1346 and the second actionable item 1322 are associated with the second milestone 1312. Dialog box 1348 may be presented when selecting shadow flow control item 1346. Dialog box 1348 may be presented when a pointer is over shadow flow control item 1346. Dialog box 1348 may present options for shadow flow control item 1346. For example, options for shadow flow control item 1346 may comprise: information, configuration, and/or deletion.

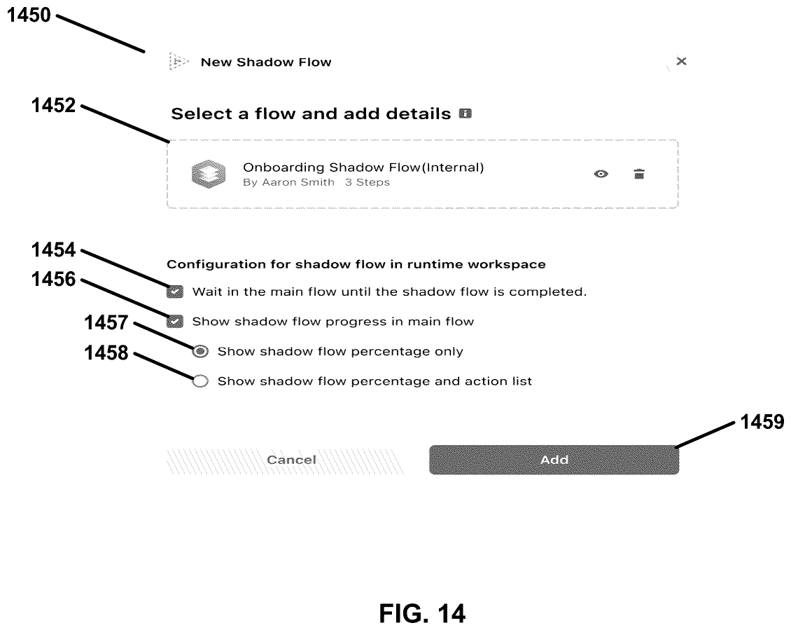

FIG. 14 illustrates example options for configuring a shadow flow, consistent with disclosed embodiments. Dialog box 1450 may be presented when a shadow flow control item is selected in a first workflow. Dialog box 1450 may be presented when a shadow flow control item configuration option is selected in a first workflow. A second workflow may be selected in shadow flow selector box 1452. A wait option may be selected or deselected through employment of wait option check box 1454. A show progress option may be selected or deselected through employment of show progress check box 1456. A show shadow flow percentage option may be selected or deselected through employment of show shadow flow percentage radio button 1457. A show shadow flow actions option may be selected or deselected through employment of show shadow flow actions radio button 1458. The second workflow selected in shadow flow selector box 1452 may be linked to the first workflow when add button 1459 is selected.

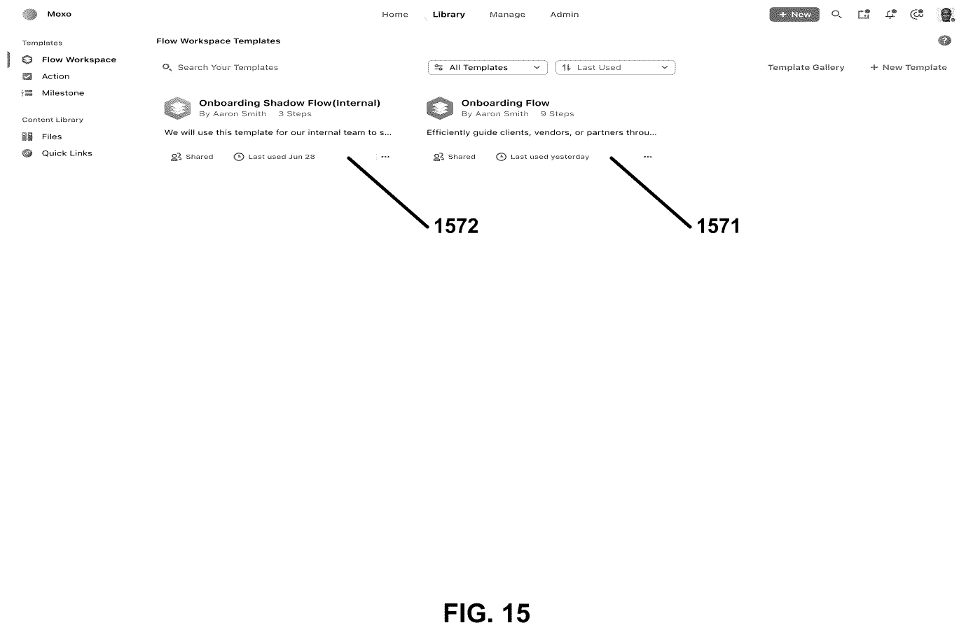

FIG. 15 illustrates an example workflow template library presentation with an example first workflow template description 1571 and an example second workflow template description 1572, consistent with disclosed embodiments. The workflow template library presentation may illustrate descriptions of one or more workflow templates. The one or more workflow templates may be stored in a workflow template database.

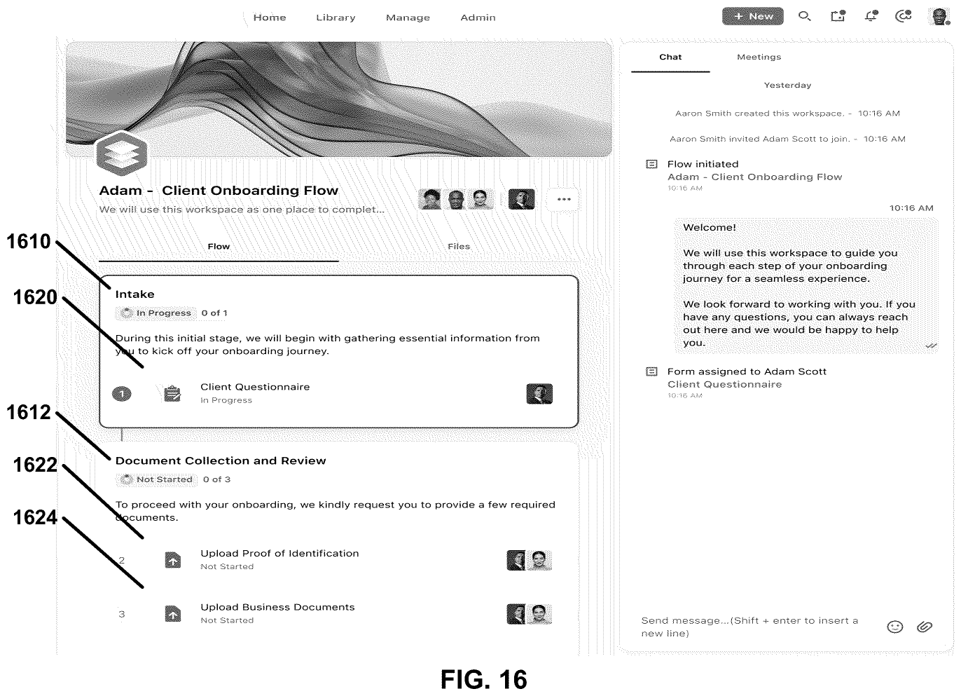

FIG. 16 illustrates an example first workflow presentation prior to first completion instructions, consistent with disclosed embodiments. The first workflow presentation may illustrate a first workflow with a first milestone 1610. The first workflow may comprise a first actionable item 1620. The first actionable item 1620 may comprise a form. In this example, the form may comprise a client questionnaire. In this example, the first actionable item 1620 is associated with the first milestone 1610. Therefore, in this example, once the form of the first actionable item 1620 is complete, the first milestone 1610 may be marked as complete automatically. The first workflow may comprise a second milestone 1612. The first workflow may comprise a second actionable item 1622. The second actionable item 1622 may comprise a file request. In this example, the file request may comprise proof of identification. The first workflow may comprise a third actionable item 1624. The third actionable item 1624 may comprise a file request. In this example, the file request may comprise one or more business documents. In this example, the second actionable item 1622 and the third actionable item 1624 are associated with the second milestone 1612. Therefore, in this example, once the items associated with the second milestone are complete, the second milestone 1612 may be marked as complete automatically. The first workflow may comprise a control item. The control item may comprise a link to a second workflow. The control item may be hidden in the first workflow presentation. The control item may be hidden in the first workflow presentation prior to an automated workflow system receiving first completion instructions.

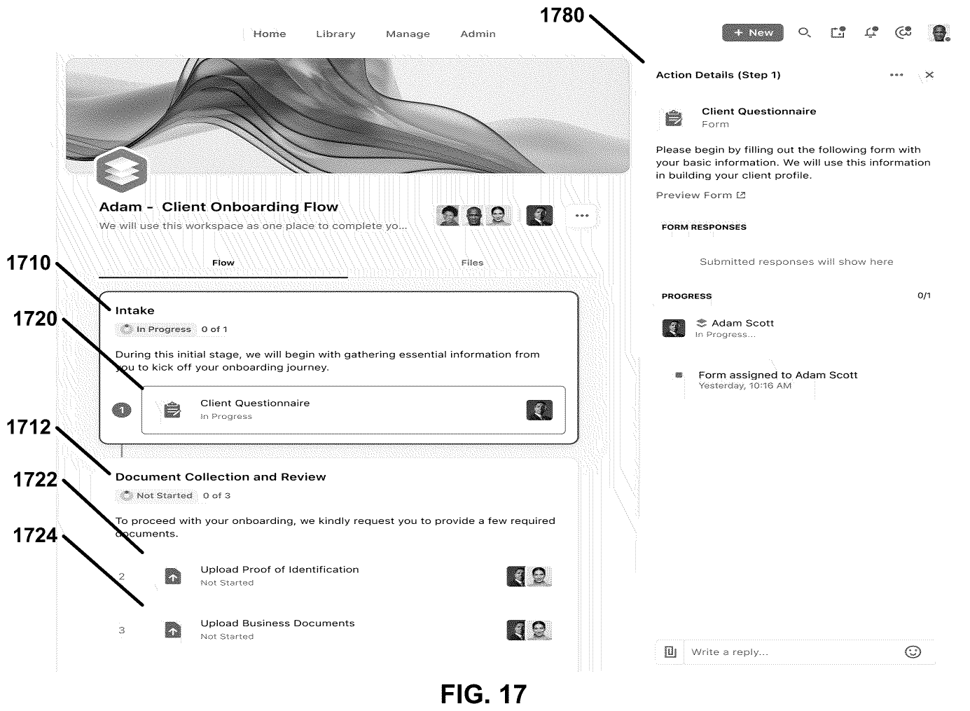

FIG. 17 illustrates an example first workflow presentation prior to first completion instructions with an example actionable item selection, consistent with disclosed embodiments. The first workflow presentation may illustrate a first workflow with a first milestone 1710. The first workflow may comprise a first actionable item 1720. The first actionable item 1720 may comprise a form. In this example, the form may comprise a client questionnaire. In this example, the first actionable item 1720 is associated with the first milestone 1710. Therefore, in this example, once the form of the first actionable item 1720 is complete, the first milestone 1710 may be marked as complete automatically. The first workflow may comprise a second milestone 1712. The first workflow may comprise a second actionable item 1722. The second actionable item 1722 may comprise a file request. In this example, the file request may comprise proof of identification. The first workflow may comprise a third actionable item 1724. The third actionable item 1724 may comprise a file request. In this example, the file request may comprise one or more business documents. In this example, the second actionable item 1722 and the third actionable item 1724 are associated with the second milestone 1712. Therefore, in this example, once the items associated with the second milestone are complete, the second milestone 1712 may be marked as complete automatically. The first workflow may comprise a control item. The control item may comprise a link to a second workflow. The control item may be hidden in the first workflow presentation. The control item may be hidden in the first workflow presentation prior to an automated workflow system receiving first completion instructions. One of the actionable items may be selected by a user viewing the first workflow presentation. In this example, first actionable item 1720 is selected. The first workflow presentation may comprise item details 1780. The item details 1780 may be associated with a selected item. In this example, the item details 1780 is associated with the first actionable item 1720.

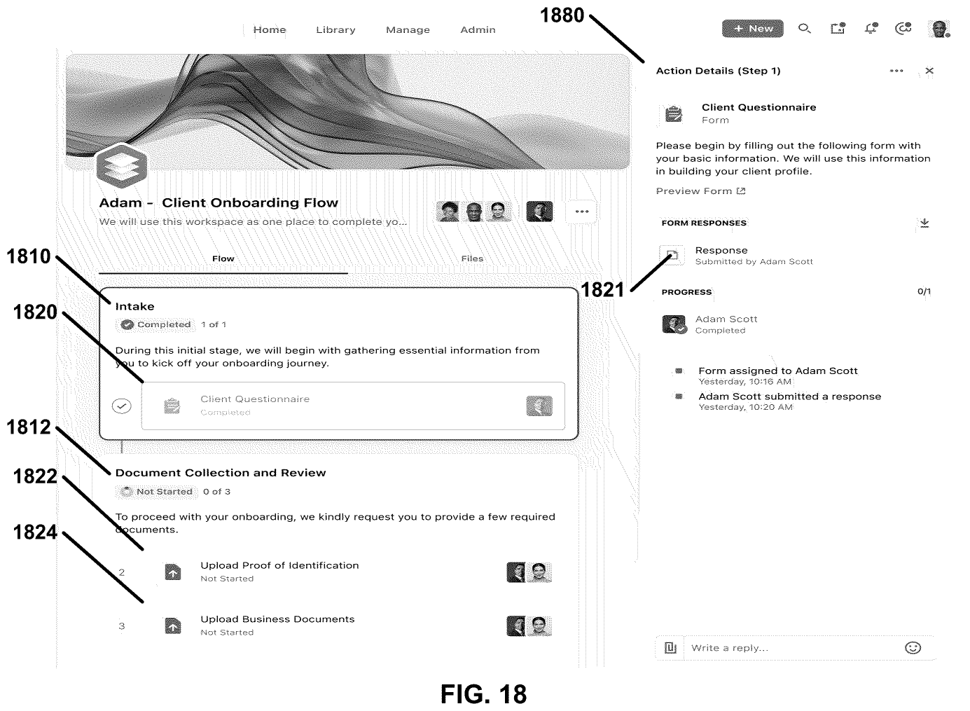

FIG. 18 illustrates an example first workflow presentation after example first completion instructions, consistent with disclosed embodiments. The first workflow presentation may illustrate a first workflow with a first milestone 1810. The first workflow may comprise a first actionable item 1820. The first actionable item 1820 may comprise a form. In this example, the form may comprise a client questionnaire. In this example, the first actionable item 1820 is associated with the first milestone 1810. The first milestone 1810 may be marked as completed (as shown). The first workflow may comprise a second milestone 1812. The first workflow may comprise a second actionable item 1822. The second actionable item 1822 may comprise a file request. In this example, the file request may comprise proof of identification. The first workflow may comprise a third actionable item 1824. The third actionable item 1824 may comprise a file request. In this example, the file request may comprise one or more business documents. In this example, the second actionable item 1822 and the third actionable item 1824 are associated with the second milestone 1812. The first workflow may comprise a control item. The control item may comprise a link to a second workflow. The control item may be hidden in the first workflow presentation. One of the actionable items may be selected by a user viewing the first workflow presentation. In this example, first actionable item 1820 is selected. The first workflow presentation may comprise item details 1880. The item details 1880 may be associated with a selected item. In this example, the item details 1880 is associated with the first actionable item 1820. The user may submit a response to an actionable item. A user device employed by the user may communicate first completion instructions to an automated workflow system. The first completion instructions may comprise first data. The first data may comprise the response. In this example, the user submitted form response 1821 to the first actionable item 1820.

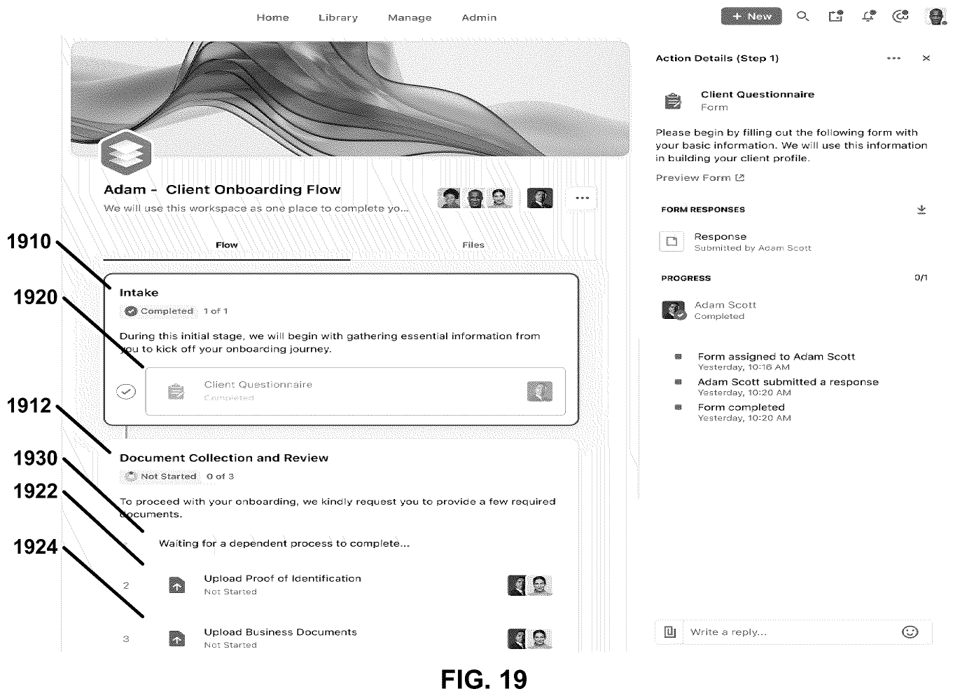

FIG. 19 illustrates an example first workflow presentation after a second workflow has been invoked, consistent with disclosed embodiments. The first workflow presentation may illustrate a first workflow with a first milestone 1910. The first workflow may comprise a first actionable item 1920. The first actionable item 1920 may comprise a form. The first actionable item 1920 may be marked as completed (as shown). In this example, the first actionable item 1920 is associated with the first milestone 1910. The first milestone 1910 may be marked as completed (as shown). The first workflow may comprise a second milestone 1912. The first workflow may comprise a control item. The control item may comprise a link to a second workflow. The control item may comprise a wait option. The first workflow presentation may illustrate show progress information 1930. The show progress information 1930 may be associated with the second workflow. The show progress information 1930 may be presented after the second workflow has been invoked. The first workflow may comprise a second actionable item 1922. The second actionable item 1922 may comprise a file request. The first workflow may comprise a third actionable item 1924. The third actionable item 1924 may comprise a file request. The second actionable item 1922 and the third actionable item 1924 may be nonactionable until the control item is complete. In this example, the control item, the second actionable item 1922, and the third actionable item 1924 are associated with the second milestone 1912. All items associated with the second milestone past the control item may be nonactionable until the control item is complete. All items past the control item in the workflow may be nonactionable until the control item is complete.

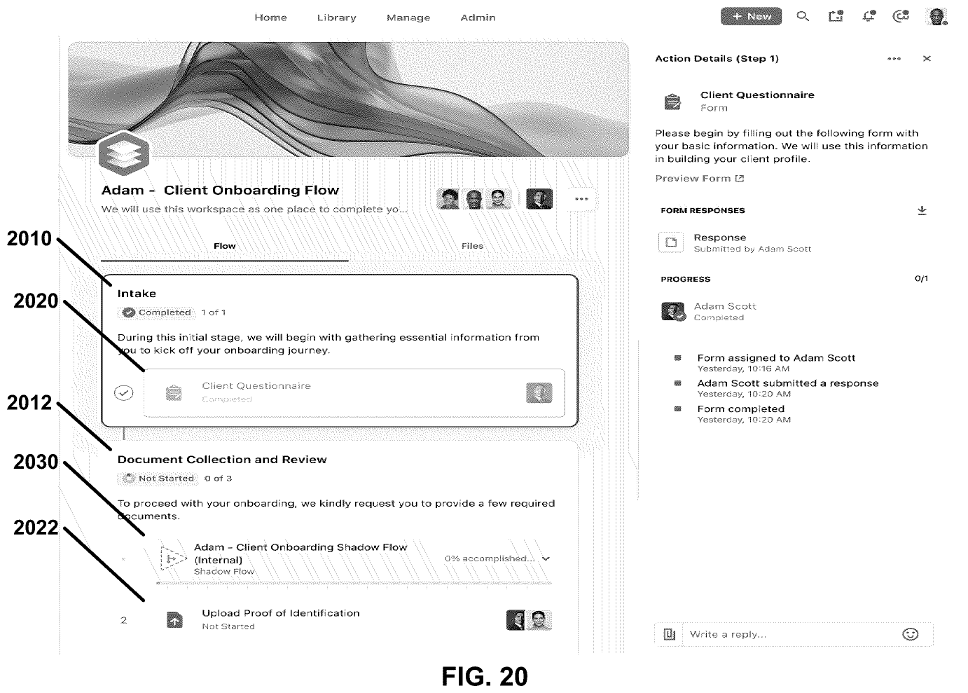

FIG. 20 illustrates an example first workflow presentation after an example second workflow has been initiated, consistent with disclosed embodiments. The first workflow presentation may illustrate a first workflow with a first milestone 2010. The first workflow may comprise a first actionable item 2020. The first actionable item 2020 may comprise a form. The first actionable item 2020 may be marked as completed (as shown). In this example, the first actionable item 2020 is associated with the first milestone 2010. The first milestone 2010 may be marked as completed (as shown). The first workflow may comprise a second milestone 2012. The first workflow may comprise a control item. The control item may comprise a link to a second workflow. The control item may comprise a wait option. The first workflow presentation may illustrate show progress information 2030. The show progress information 2030 may be presented after the second workflow has been initiated. The first workflow may comprise a second actionable item 2022. The second actionable item 2022 may comprise a file request. The second actionable item 2022 may be nonactionable until the control item is complete. In this example, the control item and the second actionable item 2022 are associated with the second milestone 2012. All items associated with the second milestone past the control item may be nonactionable until the control item is complete. All items past the control item in the workflow may be nonactionable until the control item is complete.

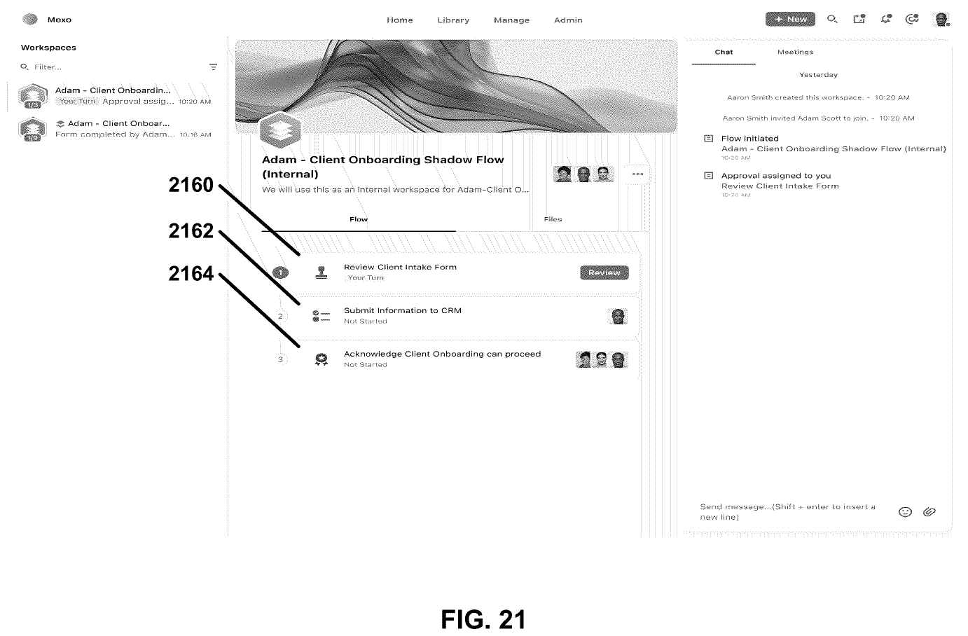

FIG. 21 illustrates an example second workflow presentation, consistent with disclosed embodiments. The second workflow presentation may illustrate a second workflow with a first actionable item 2160. The first actionable item 2160 may comprise an approval. In this example, the approval may comprise reviewing a client intake form. The client intake form may comprise data passed from a first workflow. The second workflow may comprise a second actionable item 2162. The second actionable item 2162 may comprise a task. In this example, the task may comprise submitting information to CRM. The second workflow may comprise a third actionable item 2164. The third actionable item 2164 may comprise an acknowledgement. In this example, the acknowledgement may comprise acknowledging client onboarding may proceed.

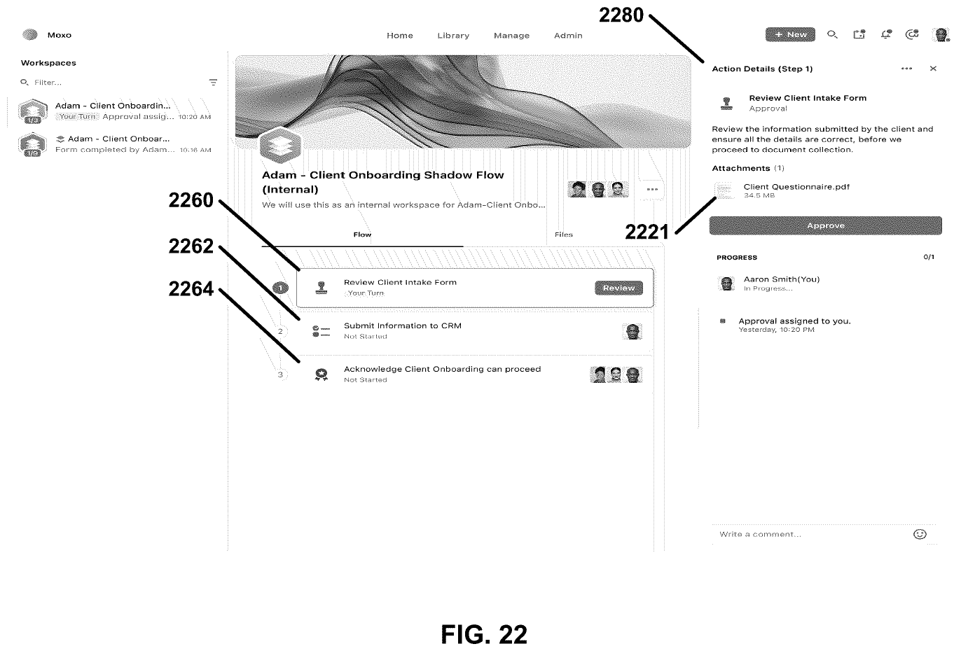

FIG. 22 illustrates an example second workflow presentation with example data passed from a first workflow, consistent with disclosed embodiments. The second workflow presentation may illustrate a second workflow with a first actionable item 2260. The first actionable item 2260 may comprise an approval. The second workflow may comprise a second actionable item 2262. The second actionable item 2262 may comprise a task. The second workflow may comprise a third actionable item 2264. The third actionable item 2264 may comprise an acknowledgement. One of the actionable items may be selected by a user viewing the second workflow presentation. In this example, first actionable item 2260 is selected. The second workflow presentation may comprise item details 2280. The item details 2280 may be associated with a selected item. In this example, the item details 2280 is associated with the first actionable item 2260. The item details 2280 may illustrate an attachment 2221 associated with the selected item. In this example, the attachment 2221 comprises data passed from the first workflow.

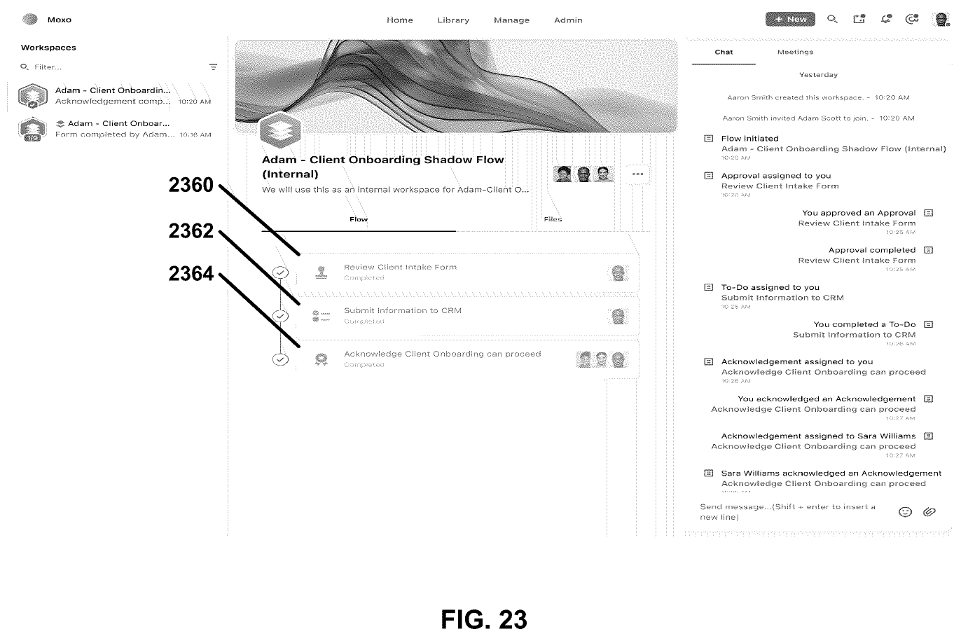

FIG. 23 illustrates an example second workflow presentation after example second completion instructions, consistent with disclosed embodiments. The second workflow presentation may illustrate a second workflow with a first actionable item 2360. The first actionable item 2360 may comprise an approval. The second workflow may comprise a second actionable item 2362. The second actionable item 2362 may comprise a task. The second workflow may comprise a third actionable item 2364. The third actionable item 2364 may comprise an acknowledgement. A user device employed by the user may communicate second completion instructions to an automated workflow system. The second completion instructions may comprise second data. The second data may comprise a notification of completion of an actionable item. In this example, the second data may comprise a notification of completion of the third actionable item 2364. The second data may comprise notification that the second workflow has completed.

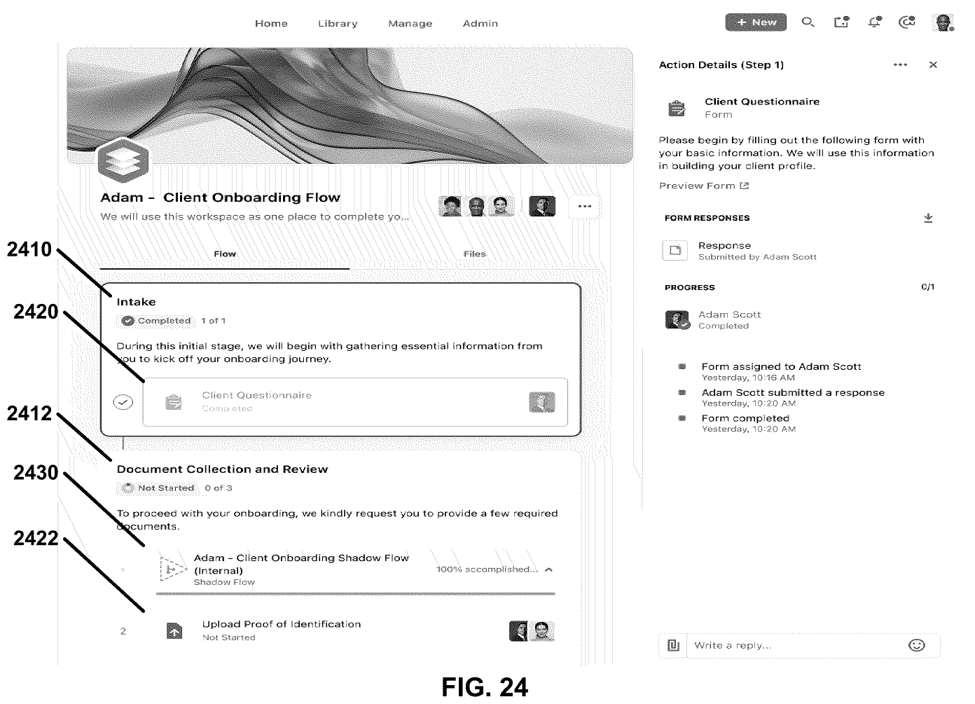

FIG. 24 illustrates an example first workflow presentation after an example second workflow has completed, consistent with disclosed embodiments. The first workflow presentation may illustrate a first workflow with a first milestone 2410. The first workflow may comprise a first actionable item 2420. The first workflow may comprise a second milestone 2412. The first workflow may comprise a control item. The control item may comprise a link to the second workflow. The control item may comprise a wait option. The first workflow presentation may illustrate show progress information 2430. The show progress information 2430 may illustrate that the second workflow has completed. The first workflow may comprise a second actionable item 2422.

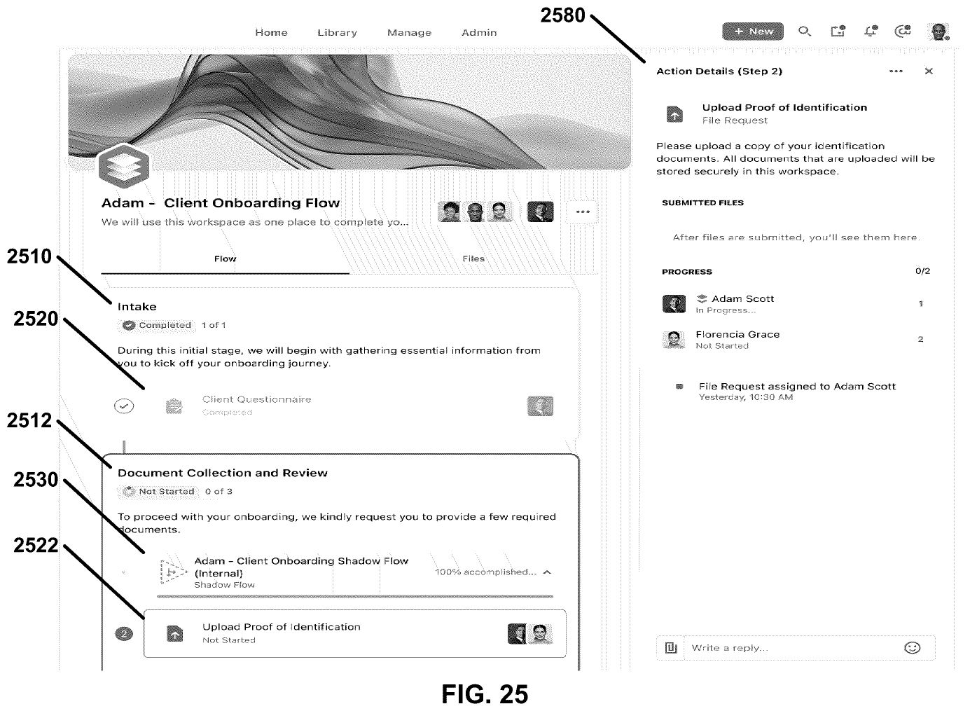

FIG. 25 illustrates an example modified workflow presentation, consistent with disclosed embodiments. The modified workflow presentation may illustrate a modified version of a first workflow. The modified version of the first workflow may comprise a first milestone 2510. The modified version of the first workflow may comprise a first actionable item 2520. The modified version of the first workflow may comprise a second milestone 2512. The modified version of the first workflow may comprise a control item. The control item may comprise a link to a second workflow. The control item may comprise a wait option. The modified workflow presentation may illustrate show progress information 2530. The show progress information 2530 may illustrate that the second workflow has completed. Actionable items past the control item may be actionable. The modified version of the first workflow may comprise second actionable item 2522. The second actionable item 2522 is actionable. In this example, the second actionable item 2522 is actionable based on the second workflow being completed. One of the actionable items may be selected by a user viewing the first workflow presentation. In this example, second actionable item 2522 is selected. The modified workflow presentation may comprise item details 2580. The item details 2580 may be associated with a selected item. In this example, the item details 2580 is associated with the second actionable item 2522.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “a”, “an”, and “one” are not to be interpreted as “only one”. In this specification, the term “may” is to be interpreted as “may, for example.” In other words, the term “may” is indicative that the phrase following the term “may” is an example of one of a multitude of suitable possibilities that may, or may not, be employed to one or more of the various embodiments. In this specification, the phrase “based on” is indicative that the phrase following the term “based on” is an example of one of a multitude of suitable possibilities that may, or may not, be employed to one or more of the various embodiments. References to “an” embodiment in this disclosure are not necessarily to the same embodiment.

Many of the elements described in the disclosed embodiments maybe implemented as operations. An operation is defined herein as an isolatable element that performs a defined function and has a defined interface to other elements. The operations described in this disclosure may be implemented in hardware, software, a combination of hardware and software, firmware, wetware (in other words, hardware with a biological clement), or a combination thereof, all of which are behaviorally equivalent. For example, operations may be implemented using computer hardware in combination with software routine(s) written in a computer language (for example, Java, HTML, XML, PHP, Python, ActionScript, JavaScript, Ruby, Prolog, SQL, VBScript, Visual Basic, Perl, C, C++, Objective-C, Rust, and/or any other computer language). Additionally, it may be possible to implement operations using physical hardware that incorporates discrete or programmable analog, digital, and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers, and microprocessors may be programmed using languages such as assembly, C, C++, and/or any other computer language. FPGAs, ASICs, and CPLDs are often programmed using hardware description languages (HDL) such as VHSIC hardware description language (VHDL) or Verilog that configure connections between internal hardware operations with lesser functionality on a programmable device. Finally, it needs to be emphasized that the above-mentioned technologies may be used in combination to achieve the result of a functional operation. Automatic operations are performed automatically and do not require human intervention to complete once executed. Automatic as defined herein does not include any time limitations unless otherwise noted.

Some embodiments may employ processing hardware. Processing hardware may comprise one or more processors, microprocessors, computer equipment, embedded systems, machines, and/or the like. Processing hardware may comprise one or more single core or multiple core processors that executes parallel processes simultaneously. For example, a processor may be a single core processor configured with virtual processing technologies. In some embodiments, a processor may use logical processors to simultaneously execute and control multiple processes. Processing hardware may implement virtual machine technologies, or other known technologies to provide the ability to execute, control, run, manipulate, and/or store multiple software processes, applications, programs, and/or the like. In another example, a processor may include a multiple core processor arrangement (e.g., dual core, quad core, etc.) configured to provide parallel processing functionalities to allow execution of multiple processes simultaneously. One of ordinary skill in the art would understand that other types of processor arrangements could be implemented that provide for the capabilities disclosed herein. The disclosed embodiments are not limited to any type of processor.

Some embodiments may employ programs. Programs may comprise instructions configured to cause processing hardware to perform operations. Programs may include one or more programs (e.g., modules, code, scripts, or functions) used to perform methods consistent with disclosed embodiments. Programs may include operating systems that perform known operating system functions when executed by one or more processors. Disclosed embodiments may operate and function with computer systems running any type of operating system. Programs may be written in one or more programming or scripting languages. In some embodiments, programs may be implemented or replicated as firmware or circuit logic. The programs and/or instructions may be stored on a machine-readable medium or memory. A memory (e.g., automated data medium) may be a medium configured to store data in a machine-readable format that may be accessed by an automated sensing device. According to some embodiments, a memory may include a volatile or nonvolatile, magnetic, semiconductor, optical, removable, non- removable, or other type of storage device or tangible (i.e., non-transitory) computer readable medium, consistent with disclosed embodiments. A memory may comprise data, instructions, programs, and/or other components.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described example embodiments. In particular, it should be noted that, for example purposes, various embodiments include an automated workflow system and a user device. However, one skilled in the art will recognize that the system and user device may vary from a traditional server/device relationship over a network such as the internet. For example, a system may be collective based: portable equipment, broadcast equipment, virtual, application(s) distributed over a broad combination of computing sources, part of a cloud, and/or the like. Similarly, for example, a user device may be a computing device, a user based client, portable equipment, broadcast equipment, virtual, application(s) distributed over a broad combination of computing sources, part of a cloud, and/or the like. Additionally, it should be noted that, for example purposes, several of the various embodiments include instructions. However, one skilled in the art will recognize that many various languages and frameworks may be employed to build and use embodiments of the present invention.

In this specification, various embodiments are disclosed. Limitations, features, and/or elements from the disclosed example embodiments may be combined to create further embodiments within the scope of the disclosure. Moreover, the scope includes any and all embodiments having equivalent elements, modifications, omissions, adaptations, or alterations based on the present disclosure. Further, aspects of the disclosed methods can be modified in any manner, including by reordering aspects, or inserting or deleting aspects.

In addition, it should be understood that any figures that highlight any functionality and/or advantages, are presented for example purposes only. The disclosed architecture is sufficiently flexible and configurable, such that it may be utilized in ways other than that shown. For example, the blocks presented in any flowchart may be re-ordered or only optionally used in some embodiments.

Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. An automated system coupled to a computer network, the system comprising:
a) at least one memory storing instructions; and
b) at least one processor configured to execute the instructions to perform operations, the operations comprising:
i) automatically communicating first workflow presentation instructions to a first user device, the first workflow presentation instructions configured to present a first workflow to a first user, the first workflow comprising a first sequence of actionable items and a control item, the control item having a link to a second workflow;
ii) electronically receiving first completion instructions from the first user device, the first completion instructions comprising first data;
iii) automatically communicating second workflow presentation instructions to a second user device, the second workflow presentation instructions configured to present the second workflow to a second user, the second workflow comprising a second sequence of actionable items; and
iv) electronically receiving second completion instructions from the second user device, the second completion instructions comprising second data.

2. The system according to claim 1, wherein the first workflow is configured for users external to an organization.

3. The system according to claim 2, wherein the second workflow is configured for users internal to the organization.

4. The system according to claim 1, wherein the link points to a start of the second workflow.

5. The system according to claim 1, wherein the second workflow is linked to the control item.

6. The system according to claim 1, wherein the second sequence of actionable items are nonactionable to the second user device until after the first completion instructions are received from the first user device.

7. The system according to claim 1, wherein actionable items past the control item in the first workflow are nonactionable to the first user device until after the second completion instructions are received from the second user device.

8. The system according to claim 7, the operations further comprising:
a) automatically generating a modified version of the first workflow, the modified version comprising actionable items past the control item being actionable; and
b) automatically communicating modified workflow presentation instructions to the first user device, the modified workflow presentation instructions configured to present the modified version of the first workflow to the first user.

9. The system according to claim 1, wherein the first data comprises at least one of:
a) data provided by the first user; or
b) a notification of completion of an actionable item preceding the control item, the actionable item in the first sequence of actionable items.

10. The system according to claim 1, wherein the second data comprises one or more of:
a) data provided by the second user;
b) a notification of completion of an actionable item in the second sequence of actionable items; or
c) a notification that the second workflow has completed.

11. The system according to claim 1, wherein the actionable items comprise one or more of the following:
a) a form;
b) a file request;
c) an approval;
d) an acknowledgement;
e) a signature;
f) a calendar item;
g) a task; or
h) an integration.

12. The system according to claim 1, wherein one or more of the actionable items includes access to an API associated with a third party service.

13. The system according to claim 1, wherein one or more of the actionable items is assignable to one or more users.

14. The system according to claim 13, wherein each of the users are associated with a workflow role.

15. The system according to claim 1, the operations further comprising:
a) automatically communicating first feed instructions to the first user device, the first feed instructions configured to present a first collaboration feed to the first user;
b) electronically receiving first collaboration instructions from the first user device, the first collaboration instructions comprising a request to add a collaboration item to the first collaboration feed;
c) automatically generating a modified first collaboration feed based on the first collaboration instructions; and
d) automatically communicating modified first feed instructions to the first user device, the modified first feed instructions configured to present the modified first collaboration feed to the first user.

16. The system according to claim 15, the operations further comprising:
a) automatically communicating second feed instructions to the second user device, the second feed instructions configured to present a second collaboration feed to the second user, the second collaboration feed distinct from the first collaboration feed;
b) electronically receiving second collaboration instructions from the second user device, the second collaboration instructions comprising a request to add a collaboration item to the second collaboration feed;
c) automatically generating a modified second collaboration feed based on the second collaboration instructions; and
d) automatically communicating modified second feed instructions to the second user device, the modified second feed instructions configured to present the modified second collaboration feed to the second user.

17. A method for automating workflow, the method comprising:
a) automatically communicating first workflow presentation instructions to a first user device, the first workflow presentation instructions configured to present a first workflow to a first user, the first workflow comprising a first sequence of actionable items and a control item, the control item having a link to a second workflow;
b) electronically receiving first completion instructions from the first user device, the first completion instructions comprising first data;
c) automatically communicating second workflow presentation instructions to a second user device, the second workflow presentation instructions configured to present the second workflow to a second user, the second workflow comprising a second sequence of actionable items; and
d) electronically receiving second completion instructions from the second user device, the second completion instructions comprising second data.

18. The method according to claim 17, wherein the second sequence of actionable items are nonactionable to the second user device until after the first completion instructions are received from the first user device.

19. The system according to claim 17, wherein the actionable items past the control item in the first workflow are nonactionable to the first user device until after the second completion instructions are received from the second user device.

20. The method according to claim 19, further comprising:
a) automatically generating a modified version of the first workflow, the modified version comprising the actionable items past the control item being actionable; and
b) automatically communicating modified workflow presentation instructions to the first user device, the modified workflow presentation instructions configured to present the modified version of the first workflow to the first user.
